(19) United States
(12) Patent Application Publication
(10) Pub. No.: US 2012/0258780 A1
(43) Pub. Date: Oct. 11, 2012

(54) GAMING DEVICE, GAME CONTROL METHOD, AND RECORDING MEDIUM

(75) Inventors: Tsuyoshi Yamaguchi, Tokyo (JP); Jun Hayashi, Tokyo (JP)

(73) Assignee: KONAMI DIGITAL ENTERTAINMENT CO., LTD., Tokyo (JP)

(21) Appl. No.: 13/427,401

(22) Filed: Mar. 22, 2012

(30) Foreign Application Priority Data
Apr. 8, 2011 (JP) 2011-086093

(51) Int. Cl. A63F 13/00

(52) U.S. Cl. 463/4

(57) ABSTRACT

A gaming device includes a release pattern prediction section which determines a prediction release pattern for the release pattern of the flying object to be released by the first personified character by selecting one of the plurality of release patterns stored in the release pattern storing section based on a selecting operation by a user operating the second personified character; and a difficulty adjustment section, which compares the release pattern determined with the prediction release pattern, and reduces the difficulty for the second character to hit back the flying object released by the first character when the release pattern determined and the prediction release pattern match.

### CROSS-REFERENCE TO RELATED APPLICATION

This application is based upon and claims the benefit of priority from the prior Japanese Patent Application No. 2011-086093, filed on Apr. 8, 2011, the entire contents of which are incorporated herein by reference.

### BACKGROUND OF THE INVENTION

1. Field of the Invention

The present invention relates to the technology that reflects the realistic sensation of the real world into various types of games including a baseball game, and the like.

2. Background Art

In conventional baseball games, it is known that a user operating a batting character makes a prediction beforehand on the course of a ball to be pitched by a pitching character, and when the prediction is correct, an advantageous condition is set in the game for the user to perform a batting operation. For example, Japanese Patent No. 4137044 discloses a baseball game in which a batter counts on the course of a ball to be pitched by a pitcher. In this configuration, the smaller is “the range counted on by the batter for the course of the ball pitched by the pitcher”, the larger the meet pointer becomes to be operated by the batter, which makes it easier for the batter to get a hit. Namely, the larger is the risk, which the batter takes by counting on the smaller range, the larger advantage the batter has when the course he counted on is right (See FIG. 5, paragraphs [0022] and [0077] of Japanese Patent No. 4137044).

By the way, in the real baseball game, the batter normally performs a batting while making a prediction for the course of the next ball to be pitched by the pitcher. In that case, important factors for the prediction made by the batter include pitch types (curve, shoot, slider, etc.) other than the ball course (high, low, outside, inside, etc.). According the technique disclosed in Japanese Patent No. 4137044, the prediction of the pitch type cannot be made in the game. Thus, it is hard to say that the foregoing conventional baseball game reflects therein the tactics in the pitcher-batter matchup in the real world, and is therefore insufficient in the point of reality evoking a real baseball game.

### SUMMARY OF THE INVENTION

An object of the present invention is to realize a gaming device and so on capable of executing a highly realistic game by reflecting the realistic sensation in the real world into various types of games such as a baseball game, and the like.

A gaming device according to one aspect of the present invention, which executes a competition wherein a flying object released by a first personified character is hit back by a second personified character, includes: an image display section for displaying an image perceived in a direction from the second personified character to the first personified character; a release pattern storing section for storing a plurality of release patterns, each defining a movement of the flying object to be released by the first personified character; a release pattern option display section for displaying the release patterns stored in the release pattern storing section in the screen as selectable release pattern options; a release pattern determination section for determining one release pattern of the flying object by the first personified character by selecting one of the release patterns stored in the release pattern storing section; a release pattern prediction section for determining a prediction release pattern for the release pattern of the flying object to be released by the first personified character by selecting one of the plurality of release patterns stored in the release pattern storing section based on a selecting operation by a user operating the second personified character; and a difficulty adjustment section for adjusting a difficulty for the second personified character to hit back the flying object released by the first personified character, the difficulty adjustment section comparing the release pattern determined by the release pattern determination section with the prediction release pattern determined by the release pattern prediction section, and reducing the difficulty when the determined release pattern and the prediction release pattern match to be lower than the difficulty in the case where the user operating the second personified character does not select the prediction release pattern.

A gaming device according to another aspect of the present invention, which executes a competition wherein a flying object released by a first personified character is hit back by a second personified character while communicating between two gaming devices, includes: an image display section for displaying an image perceived in a direction from the second personified character to the first personified character; a release pattern storing section for storing a plurality of release patterns, each defining a movement of the flying object to be released by the first personified character; a release pattern option display section for displaying the release patterns stored in the release pattern storing section in the screen as selectable release pattern options; a release pattern determination section for determining a release pattern of the flying object by the first personified character by selecting one of the release patterns stored in the release pattern storing section; a release pattern prediction section for determining a prediction release pattern for the release pattern of the flying object to be released by the first personified character by selecting one of the plurality of release patterns stored in the release pattern storing section based on a selecting operation by a user with respect to the selectable release pattern options; and a difficulty adjustment section for adjusting a difficulty for the second personified character to hit back the flying object released by the first personified character, said difficulty adjustment section comparing the release pattern determined by the release pattern determination section with the prediction release pattern determined by the release pattern prediction section, and reducing the difficulty when the release pattern determined by the release pattern determination section and the prediction release pattern determined by the release pattern determination section match, to be lower than the difficulty in the case where the user operating the second personified character does not select the prediction release pattern.

A game control method for controlling by a computer, a competitive game wherein a flying object released by a first personified character is hit back by a second personified character, includes: an image display step executed by the computer for displaying an image perceived in a direction from the second personified character to the first personified character; a release pattern storing step executed by the computer for storing a plurality of release patterns, each defining a movement of the flying object to be released by the first personified character; a release pattern option display step executed by the computer for displaying the release patterns stored in the release pattern storing step in the screen as selectable release pattern options; a release pattern determination step executed by the computer for determining a release pattern of the flying object by the first personified character by selecting one of the release patterns stored in the release pattern storing step; a release pattern prediction step executed by the computer for determining a prediction release pattern for the release pattern of the flying object to be released by the first personified character by selecting one of the plurality of release patterns stored in the release pattern storing step based on a selecting operation based on a selecting operation by a user operating the second personified character; and a difficulty adjustment section executed by the computer for adjusting a difficulty for the second personified character to hit back the flying object released by the first personified character, said difficulty adjustment section comparing the release pattern determined by the release pattern determination step with the prediction release pattern determined by the release pattern prediction step and reducing the difficulty when the release pattern determined by the release pattern determination step and the prediction release pattern determined by the release pattern determination step match, to be lower than the difficulty in the case where the prediction release pattern is not selected.

A computer readable recording medium recorded with a game control program according to still another aspect of the present invention, which executes a competitive game wherein a flying object released by a first personified character is hit back by a second personified character, for causing a computer to execute: an image display step for displaying an image perceived in a direction from the second personified character to the first personified character; a release pattern storing step for storing a plurality of release patterns, each defining a movement of the flying object to be released by the first personified character; a release pattern option display step for displaying the release patterns stored in the release pattern storing step in the screen as selectable release pattern options; a release pattern determination step for determining a release pattern of the flying object by the first personified character by selecting one of the release patterns stored in the release pattern storing step; a release pattern prediction step for determining a prediction release pattern for the release pattern of the flying object to be released by the first personified character by selecting one of the plurality of release patterns stored in the release pattern storing step based on a selecting operation based on a selecting operation by a user operating the second personified character; and a difficulty adjustment section for adjusting a difficulty for the second personified character to hit back the flying object released by the first personified character, said difficulty adjustment section comparing the release pattern determined by the release pattern determination step with the prediction release pattern determined by the release pattern prediction step and reducing the difficulty when the release pattern determined by the release pattern determination step and the prediction release pattern determined by the release pattern determination step match, to be lower than the difficulty in the case where the prediction release pattern is not selected.

Further objects, features and advantages of the present invention will become more apparent upon reading the following description. Advantages of the present invention will be more apparent upon reading the following description with reference to the accompanying drawings.

### BRIEF DESCRIPTION OF THE DRAWINGS

FIG. 1 is a block diagram illustrating a configuration of a gaming device according to one embodiment of the present invention;

FIG. 2 is a diagram illustrating a game screen according to one embodiment of the present invention;

FIG. 3 is a diagram illustrating a game screen according to one embodiment of the present invention;

FIG. 4 is a diagram explaining effects of the configuration according to one embodiment of the present invention on operations in a game;

FIG. 5 is a diagram illustrating changes over time of a partially enlarged view of FIG. 3;

FIG. 6 is a function block diagram explaining major functions in one embodiment of the present invention;

FIG. 7 is a function block diagram explaining major functions in another embodiment of the present invention;

FIG. 8 is a flowchart explaining major functions in one embodiment of the present invention;

FIG. 9 is a flowchart illustrating steps following the flowchart of FIG. 8;

FIG. 10 is a block diagram illustrating a connection example of two gaming devices when executing a competitive online game between them according to one embodiment of the present invention;

FIG. 11 is a block diagram illustrating another connection example of two gaming devices when executing a competitive online game between them according to one embodiment of the present invention;

FIG. 12 is a block diagram illustrating a state in which two controllers are connected to a gaming device according to one embodiment of the invention; and

FIG. 13 is a function block diagram explaining major functions according to another embodiment of the present invention.

### DETAILED DESCRIPTION OF THE PREFERRRED EMBODIMENTOF THE INVENTION

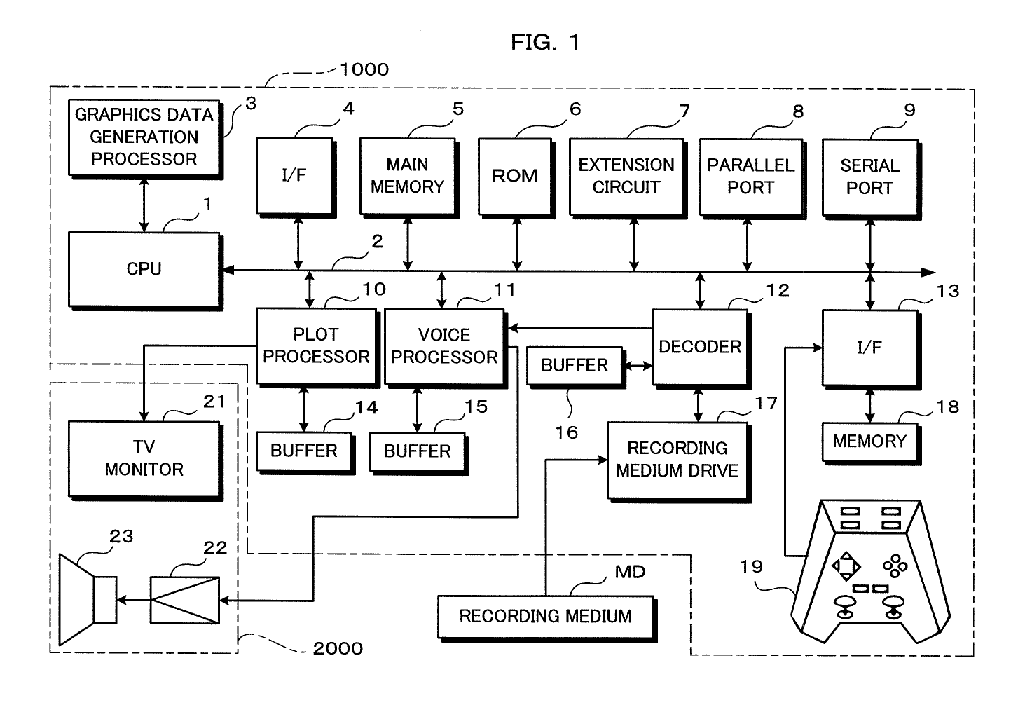

In the following, a gaming device according to one embodiment of the present invention is described, by way of example, with reference to the accompanying drawings. FIG. 1 is a block diagram illustrating a configuration of a gaming device according to one embodiment of the present invention. As one example of the gaming device, the following explanations will be given through the case of a gaming device constituted by connecting a home video gaming device to a home television. It should be noted here that such gaming device is given merely as one example, and the present invention is also applicable to other gaming devices, such as portable gaming devices integrally formed with monitors, or portable phones, PHSs (Personal Handy-phone System) terminals, portable information terminals (PDA: Personal Digital Assistant), smartphones that are portable terminals having integrated therein portable phones and portable information terminals, personal computers, tablet computers, and the like, which function as the gaming devices by executing a game control program according to the embodiment of the present invention.

The gaming device shown in FIG. 1 includes a home gaming device 1000, and a television 2000. A computer readable recording medium MD having recorded thereon a game control program is mounted in the home gaming device 1000, and the game control program is read out as necessary from the recording medium MD, whereby the game is executed. The home gaming device 1000 includes a CPU (Central Processing Unit) 1, a bus line 2, a graphics data generation processor 3, an interface circuit (I/F) 4, a main memory 5, a ROM (Read Only Memory) 6, an expansion circuit 7, a parallel port 8, a serial port 9, a drawing processor 10, a sound processor 11, a decoder 12, an interface circuit (I/F) 13, buffers 14 to 16, a recording medium drive 17, a memory 18, and a controller 19. The television 2000 includes a television monitor 21, an amplifier circuit 22 and a speaker 23.

The CPU 1 controls the entire gaming device according to the game control program recorded in the recording medium MD and an operating system recorded in the ROM 6. Specifically, the CPU 1 performs a setting of a game space that is a virtual space, and arranges in the virtual space, a virtual light source, a virtual camera, characters, as well as objects which constitute the background of the characters, and the like. Here, the CPU 1 ensures in the main memory 5, etc., the area for storing coordinate axes which determine the game space, the position indicative data of the virtual light source, a camera, characters, the objects and the like, and writes the position indicative data of the objects, and the like in the area thus secured, whereby the characters and the like are arranged in the space. For the game space, for example, a virtual 3D space may be used. Additionally, the CPU 1 calculates momentum data and rotation data for operating characters according to an operation command input by the user using the controller 19.

The graphics data generation processor 3 is a coprocessor of the CPU 1. The graphics data generation processor 3 computes the position indicative data after the character has been moved based on the momentum data and the rotation data as computed by the CPU 1, and returns the position indicative data as computed to the CPU 1.

The interface circuit 4 is a circuit for connecting peripheral devices, including pointing devices such as a mouse, a track ball, or the like. The main memory 5 is made up of a RAM (Random Access Memory). The ROM 6 stores therein the operating system of the gaming device.

The expansion circuit 7 expands the data compressed according to the MPEG (Moving Picture Experts Group) standard and the JPEG (Joint Photographic Experts Group) Standard. The parallel port 8 and the serial port 9 are used for connecting various types of peripherals.

The plot processor 10 performs the rendering of the characters, the objects which the CPU 1 sets in the game space at a predetermined frame rate, according to plotting instructions from the CPU 1, and generates two-dimensional image data. The image data as generated is output to the television monitor 21. The buffer 14 is used as the work memory of the plot processor 10.

The sound processor 11 stores sound data such as ADPCM (Adaptive Differential Pulse Code Modulation) data as read from the recording medium MD in the buffer 15, and outputs the sound data as read from the buffer 15 through the speaker 23 according to a sound output command from the CPU 1. The buffer 15 is used as the work memory of the sound processor 11.

For example, the recording medium drive 17 is made up of a DVD-ROM drive, a CD-ROM drive, a hard disk drive, an optical disk drive, a flexible disk drive, a silicon disk drive, a cassette medium reading device, etc. The recording medium MD is made up of a DVD-ROM, a CD-ROM, a hard disk, an optical disc, a flexible disk or a semiconductor memory, etc., and stores therein the game control program according to the embodiment of the present invention. The game control program includes program data, image data for plotting the characters or the objects, audio data for reproducing sound effects of the game, or the like.

The recording medium drive 17 reads the image data, the audio data, and the program data from the recording medium MD, and supplies the data as read to the decoder 12. The decoder 12 performs the error correction processing based on the ECC (Error Correction Code) with respect to the image data, the audio data, and the program data supplied from the recording medium drive 17, and supplies the image data as processed to the main memory 5 or the sound processor 11.

For example, the memory 18 is made up of a memory card. The memory card, for example, stores therein the state at the time of the interruption when the game is interrupted. The interface circuit 13 is used for connecting the memory 18.

The controller 19 is an operation device which permits the user as an operator to input various types of operation commands. The controller 19 outputs a signal according to the operation command as input by the user to the CPU 1. Specifically, the controller 19 is provided with a pair of left and right joy sticks and a variety of buttons. The user inputs operation commands by tipping the joy stick, or depressing the buttons. The amplifier circuit 22 amplifies the sound data as output from the sound processor 11 and outputs the sound data as amplified to the speaker 23.

[Explanations on Pitch Type Prediction in Baseball Game to which Present Invention is Applied]

In the following, the embodiment wherein the present invention is applied to the baseball game is described. The embodiment relates to the technique of realizing a highly realistic baseball game by reflecting thereto the realistic sensation of the baseball game in the real world, and more specifically relates to a configuration wherein a user operating the batting character makes a prediction of the pitch type to be pitched by a pitching character beforehand, and when the prediction of the pitch type is correct, the user operating the batting character has an advantage in relation to a batting operation to be performed by the batting character.

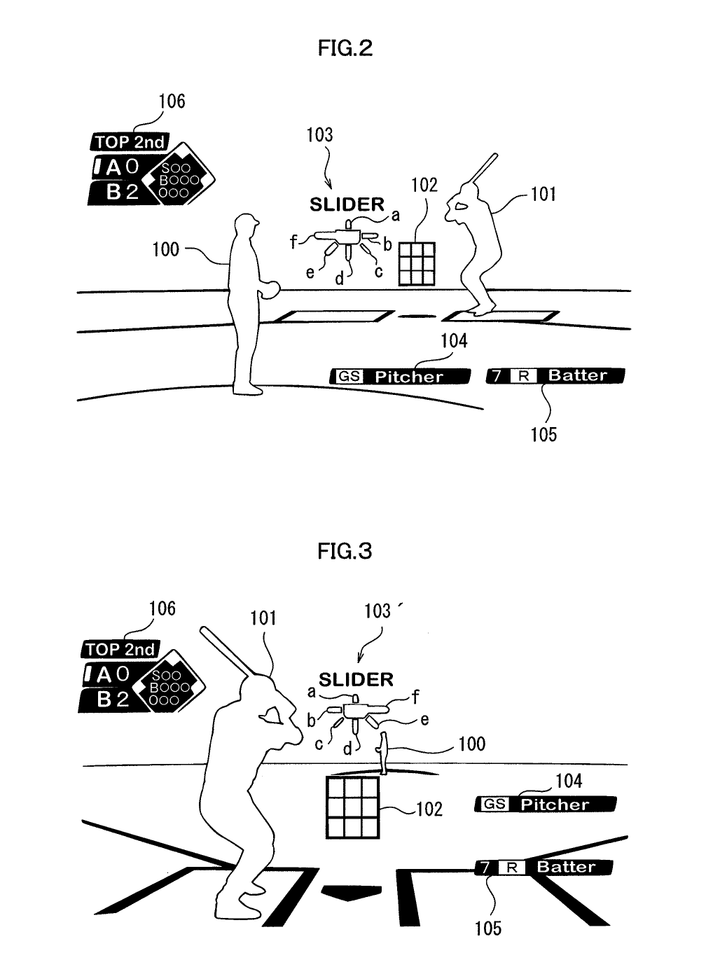

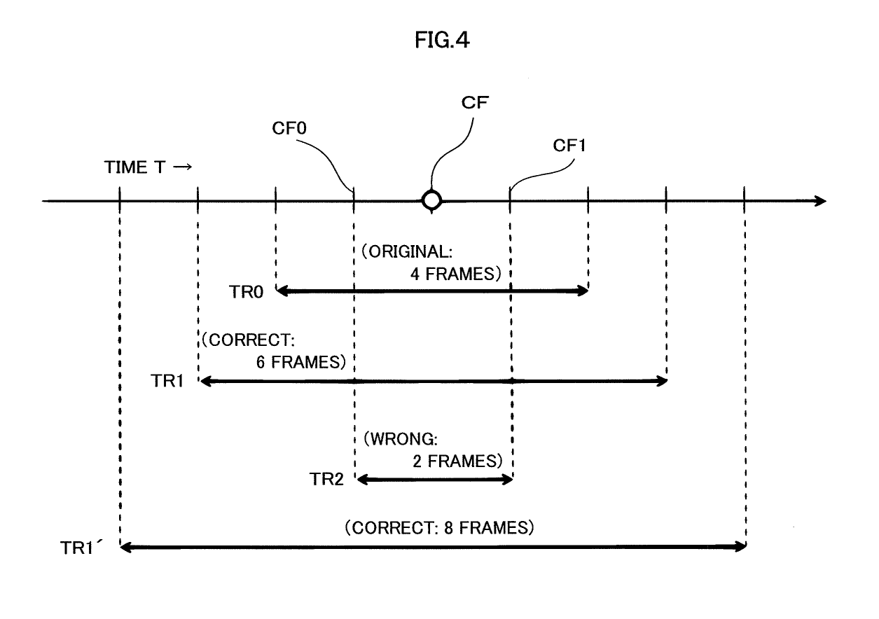

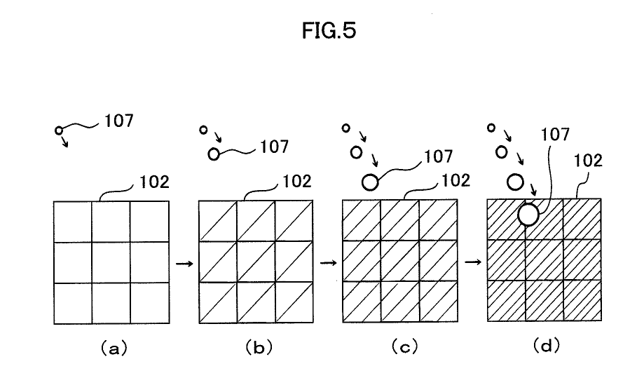

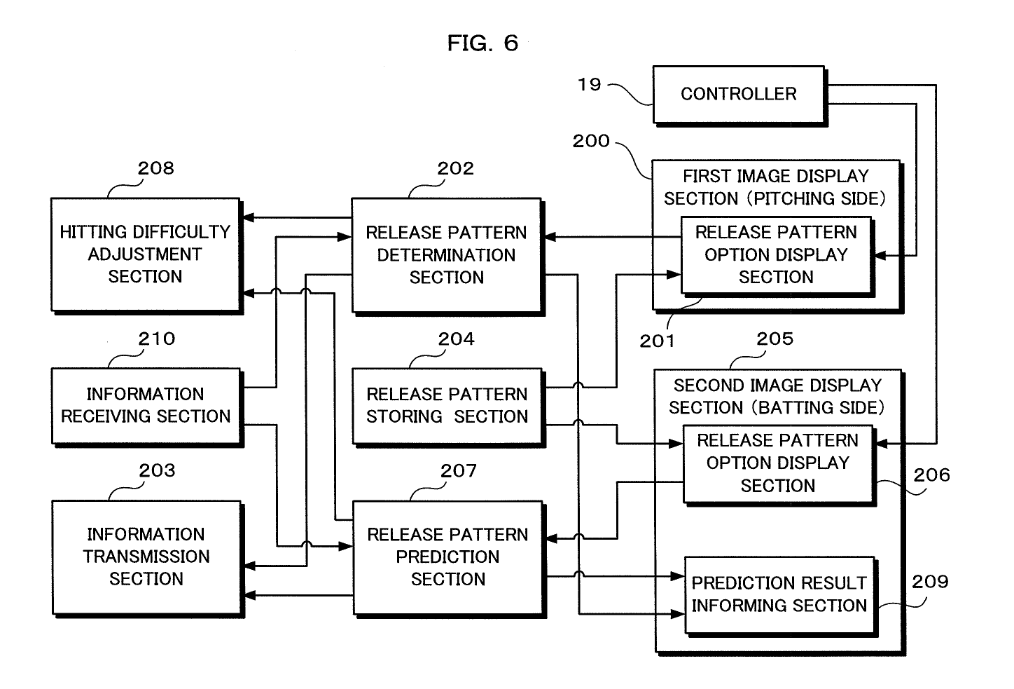

FIGS. 2 and 3 illustrate game screens to be displayed in the monitor of the gaming device, according to one embodiment wherein the present invention is applied to the baseball game. FIG. 4 is a diagram explaining the effects of the configuration on operations in the game according to one embodiment of the present invention. FIG. 5 is a diagram illustrating changes over time of a partially enlarged view of FIG. 3. FIG. 6 is a function block diagram explaining major functions in one embodiment of the present invention, which corresponds to parts of the CPU 1. In the following, explanations will be given with reference to FIG. 2 through FIG. 6 as necessary. It is assumed that two users have an online match via a network in the embodiment. Further, as will be explained later, the essential characteristics of the present invention lie in the batting operation to be performed by the user operating the batting character and the display in the screen on the side of the user operating the batting character illustrated in FIG. 3.

FIG. 2 shows the state before a pitching character 100 (to be operated by the first user) pitches against a batting character 101 (to be operated by the second user). FIG. 2 clearly shows an image perceived in a direction from the pitching character to the batting character, and the user operating the pitching character 100 plays a game while viewing this image when carrying out a pitcher-batter matchup. The explanations on the user operating the batting character 101 plays a game while viewing the screen when seen in the opposite direction as will be explained later. In FIG. 2, a reference numeral 102 indicates a strike zone, and a reference numeral 103 indicates a pitch type selection icon (release pattern options). The pitch type selection icon 103 shows the pitch types that the pitching character 100 has, and the pitch type can be selected as desired by operating the controller 19 of the gaming device.

The pitch type selection icon 103 is made up of six lines a, b, c, d, e and f that extend from the center to the surroundings. These six lines a, b, c, d, e and f respectively indicate pitch types. In the pitch type selection icon 103 shown in FIG. 2, the line a indicates “Straight”, the line b indicates “Shoot”, the line c indicates “Sinker”, the line d indicates “Fork”, and the line e indicates “Curve”, and the line f indicates “Slider” in the clockwise direction from the top.

When any of the foregoing pitches is indicated by the corresponding line, the wording for the pitch type is displayed above the pitch type selection icon 103. Additionally, when the user selects any of the pitch types by the controller 19, the line corresponding to the selected pitch type is displayed thick.

In this example, the slider corresponding to the line f is selected (for example, the slider is selected by using an analog stick, and the selection is confirmed by depressing the confirm button). In the example shown in FIG. 2, the pitching character 100 has the above six pitch types. However, the number of the pitch types the pitching character 100 has is different for each pitching character 100, and some pitching characters 100 may have two or three pitch types.

Here, for the pitch type selection icon 103, the line shaped figure that can be intuitively selected is adopted as indicated above. However, the invention is not intended to be limited to the line shaped figure, as long as the pitch type can be selected. For example, it may be designed so as to select the pitch type from the list of the pitch types shown in a table. In the screen, provided are a column 104 where name, etc., of the pitching character 100 are displayed, and a column 105 where name etc., of the batting character 101 are displayed. Here, the pitcher's name is displayed as “Pitcher”, and the batter's name is displayed as “Batter”. On the left side of the column 105, the uniform number of the batting character, and “R” indicative of the right-handed or “L” indicative of the left-handed are shown. Moreover, a scoreboard 106 is displayed, in which the scores and the count, etc. of the game are shown.

FIG. 3 shows an image of the state shown in FIG. 2 when seen from the batting side toward the pitching side. The user operating the batting character 101 plays a game while viewing this screen. The pitch type selection icon 103′ shown in FIG. 3 is a horizontally reversed display of the pitch type selection icon 103 shown in FIG. 2. The items displayed in the screen are the same as those of FIG. 2 except that the pitch type selection icon 103 and the pitch type selection icon 103′ are horizontally reversed, and therefore explanations thereof shall be omitted here.

The user operating the batting character 101 makes a prediction of the pitch type for the next ball to be pitched by the pitching character 100 before the pitcher character 100 enters into the throwing motion, and based on the prediction, among the six pitch types indicated in the pitch type selection icon 103, a specific pitch type is selected by using the controller 19 of the gaming device 1000 (for example, the pitch type is selected by using the analog stick, and the selection is confirmed by depressing the confirm button.). In the example of FIG. 3, “Slider” is selected. Here, it is an option whether the user operating the batting character 101 makes a prediction of the pitch type for the next ball to be pitched, and if the user does not make the prediction, the foregoing selection is not made. Moreover, in the case where any of the pitch types is originally selected by default, it can be designed such that the prediction of the pitch type is not made unless the determination button is depressed.

It may be also designed such that without displaying the pitch type selection icon 103 or 103′ shown in FIG. 2 and FIG. 3 in the screen, the pitch type can be selected only by operating the buttons, etc., of the controller 19. However, in view of that the pitch type selection by the user becomes easier by displaying the pitch type selection icon 103, 103′ in the screen, it is desirable that the pitch type selection icon 103, 103′ be displayed.

By the way, the user operating the batting character 101 is the one who makes a prediction of the pitch type. In the following explanations, however, the description on the user may be omitted, and such expression “the batter character 101 makes a prediction of the pitch type” may be used for convenience' sake. Similarly, in the case where the user operating the pitching character 100 exists, the user operating the pitching character 100 is the one who makes a selection of the pitch type. However, such expression “the pitching character 101 makes a selection of the pitch type” may be used for convenience' sake.

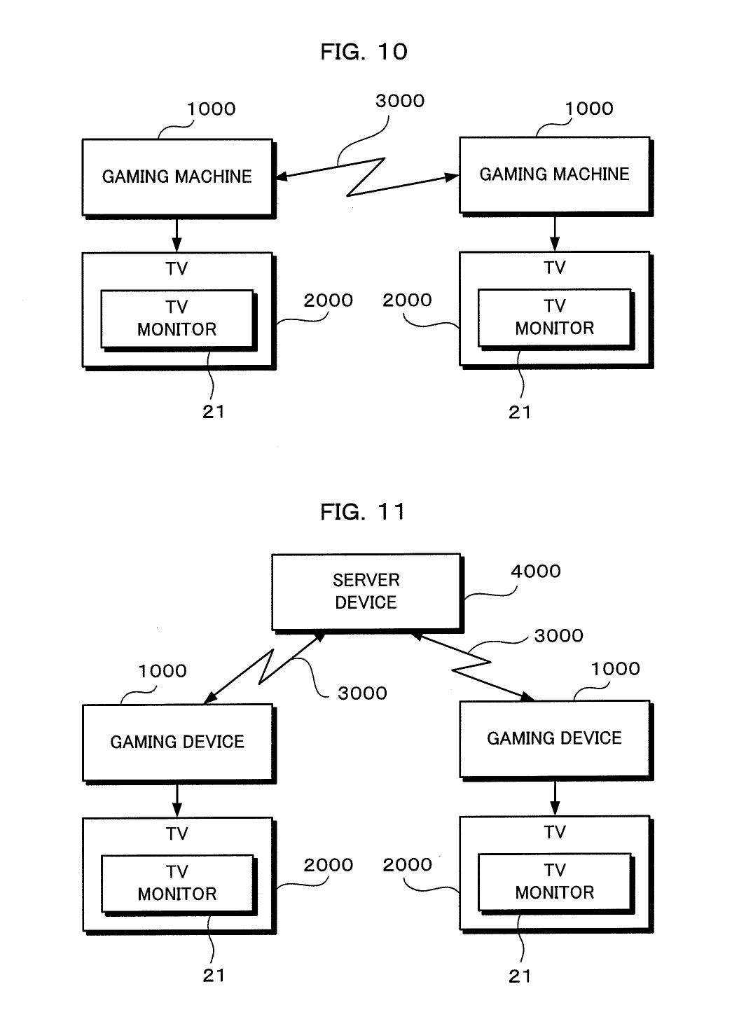

In the case where two users make an online competition via a network as shown in FIG. 10 and FIG. 11, two game devices 1000 respectively operated by the two users are connected so as to allow communications via the network 3000. For the network 3000, an internet, a public line (telephone line and mobile communication line, etc.), a cable LAN (Local Area Network), a wireless LAN, Bluetooth (registered trademark), and a UWB (Ultra Wide Band), etc., or combinations thereof may be used.

For the online competition via the network, a game system in which a competition is made among a plurality of gaming devices by making direct data exchanges among them, a so-called P2P (peer to peer) connection system may be adopted. Moreover, a radio-communication competition in ad hoc mode which permits a plurality of gaming devices to directly perform radio-communications, or a telecommunication competition via communication cable may be adopted, which fall under the P2P connection system. In the online competition, for example, two gaming devices 1000 develop a common virtual game space, while making synchronization with one another by the P2P communications, and the game proceeds in the virtual game space.

For the online competition system via the network, as show in FIG. 11, a so-called client/server connection system may be adopted in which a plurality of gaming devices 1000 as clients compete against each other via the server device 4000. Namely, the competitive game in which the ball object thrown by the pitching character is hit by the batting character is carried out between the two gaming devices 1000 while making communications between them, and the communications may be performed via the server device 4000.

As shown in FIG. 10 and FIG. 11, in the case where two users compete against one another via the network, the screen of FIG. 2 and the screen of FIG. 3 are displayed in the television monitors 21 of the televisions 2000 connected to two gaming devices 1000 respectively. Namely, the screen of FIG. 2 is displayed in the television monitor 21 of the gaming device 1000 on the side of user operating the pitching character 100, while the screen of FIG. 3 is shown in the television monitor 21 of the gaming device 1000 on the side of the user operating the batting character 101. In this case, the user operating the batting character 101 cannot see the screen of FIG. 2, and therefore is not able to recognize the pitch type selected by the opponent using the pitch type selection icon 103. Similarly, the user operating the pitching character 100 cannot see the screen of FIG. 3, and therefore is not able to recognize the pitch type predicted by the opponent using the pitch type selection icon 103′.

In FIG. 2 and FIG. 3, the pitch type of the next ball predicted by the batting character is “Slider”, which is identical with the pitch type selected by the pitching character 100 of the opponent. As described, when the batting character's prediction of the pitch type comes up, the setting is performed so that the batting character 101 becomes able to perform a batting operation under more advantageous condition. Hereinafter, this characteristic feature will be explained with reference to FIG. 4.

FIG. 4 indicates a time course when the ball object approaches the batting character 101, and shows a time zone (hit operable time) in which the ball object moving over time can be hit by a bat. First, explanations will be given in the case where the batting character 101 performs a batting operation without making a prediction of the pitch type.

In FIG. 4, the horizontal axis indicates the time course of the movement of the ball object; each unit indicates a piece, i.e., one frame unit of the image which constitutes a game image. Then, when the batting character 101 performs a batting operation at timing the ball object locates in a center frame CF at the center of the horizontal axis, the ball object flies towards the center field. On the other hand, when the batting character 101 performs a batting operation before the above timing, the earlier the timing the batting operation is performed, the more ahead of time the batting character 101 hits the ball object before the ball object enters the bosom portion of the batting character 101. Thus, the batting character 101 so-called pulls the ball object when hitting in the real baseball game. On the contrary, when the batting character 101 performs a batting operation at timing after the ball object passes the center frame (CF) (center) (in the direction of CF1), the batting character so-called hits in an opposite way. In this example, the timing at which the bat hits the ball object is limited to the time period of four frames indicated by TR0 in the figure for the following reason. That is, if it is designed such that the bat can hit the ball object even when the timing is off to a large extent, the batting operation would be less difficult, which would make the user feel less realistic, and the game itself would be less interesting. If the bat does not hit the ball object within the time period of four frames, the batting character misses the ball.

In the foregoing configuration of the present embodiment, whether or not the bat hits the ball is determined based on whether or not the bat as swung passes the predetermined movement range of the ball object within the predetermined hit operable time. Therefore, according to the foregoing configuration of determining the hitting operation, the coordinates of the ball object are not necessarily be precisely coincided with the coordinates of the bat object in the virtual space, but some play in term of time is allowed.

Next, explanations will be given with regard to the case where the user operating the batting character 101 makes a prediction of the pitch type, and the user's prediction is correct. When the prediction is correct, as shown in TR1 in FIG. 4, the hit operable time is increased to six frames from the four frames TR1 set for the case where the prediction is not made, by adding one frame each at the beginning and the back of the four frames TR1. Therefore, when the user performs a batting operation, the possibility of the bat hitting a ball object becomes higher. On the other hand, in the case where the user makes a prediction of the pitch type, and the prediction is wrong, as shown in TR2 in FIG. 4, the hit operable time is reduced to two frames from the four frames TR0 set for the case where the prediction is not made, by reducing one frame each from the beginning and the back of the four frames TR0. As described, when the prediction of the pitch type does not come up, a penalty element of reducing a hit operable time is provided. On the other hand, when the prediction is not made on the pitch type, there would be no chance of increasing the hit operable time, but there would be no risk of reducing the hit operable time either. Thus, whether or not to make a prediction of the pitch type is up to the user's decision.

By the way, the larger is the number of the pitch types, the more the prediction of the pitch type made by the batting character becomes difficult. For example, there is a significant difference in difficulty of making a prediction of the pitch type between the case where the pitching character has eight pitch types and the case where the pitching character has three pitch types. In view of the foregoing, it may be designed so as to vary the length of the hit operable time according to the number of pitch types the pitching character has when the prediction is correct (the larger is the number of the pitch types, the longer is the hit operable time). For example, in the case where the pitching character has pitch types of seven or more, if the prediction of the pitch type comes up, as shown by TR′ in FIG. 4, the hit operable time may be further increased by two frames from six frames to eight frames. In this example, the two hit operable times are set for respectively the case where the number of pitch types is less than seven and the case where the number of pitch types is seven or larger. However, three or more hit operable times may be set according to the number of the pitch types the pitching character has.

The foregoing embodiment has been explained through the case of increasing the hit operable time when the prediction of the pitch type comes up. However, any other configurations which allow the batting character to have some advantage may be adopted. For example, 1) the speed of a pitched ball is reduced by 5% from the original speed; 2) in the case where the pitch type is a curve ball, a change of a pitched ball is reduced from the original change; and 3) an area of the strike zone is slightly increased from the original strike zone so that it becomes possible to hit in a certain area which is originally outside the strike zone (ball zone), and the like. On the other hand, if the prediction is wrong, contrary to the above, it may be arranged such that 1) the speed of a pitched ball is increased from the original speed; 2) the change of a pitched ball is reduced from the original change for the curve ball; and 3) the area of the strike zone is reduced from the original strike zone, and the like.

Next, the method of informing the user of the result (correct/wrong) of the pitch type prediction will be explained.

In the present embodiment, as described above, the difficulty in hitting the ball changes according to the result of the pitch type prediction. Thus, it can be said that the result of the pitch type prediction will be reflected in the operation and the development of the game. However, some users may not be able to precisely recognize if the prediction of the pitch type was correct or wrong from the feeling when hitting. Specifically, the user may not be able to recognize whether he/she could get a hit as a result of the correct prediction or with his/her skillful operation despite of the wrong prediction and the user may not be able to progress the game reasonably. In response, in the present embodiment, it is designed to inform the user of the information on the result of the pitch type prediction clearly to his/her satisfaction, which in turn makes is possible to allow the user to reflect the information on the result of the prediction into the operations in the game.

Specifically, first, the batting character 101 (user) makes a prediction of the pitch type before the pitching character 100 enters into a throwing motion. Thereafter, the pitching character 100 starts the throwing motion, and further immediately after the ball is pitched from the pitching character 100, the color of the strike zone 102 is changed depending on whether the prediction of the pitch type is correct or not. For example, when the prediction of the pitch type is correct, the color of the strike zone 102 is changed from transparent or white to red. On the other hand, when the prediction of the pitch type does not come up, the color of the strike zone 102 is changed to blue. With this configuration, the user becomes able to recognize whether or not the prediction of the pitch type is correct immediately after the ball object is released by the pitching character 100. As a result, the user is able to progress the game reasonably.

According to the foregoing configuration, since whether the pitch type prediction is correct or not can be recognized directly after the ball object is released, it is possible to utilize that information on the result of prediction in the batting operation. For example, when the batting character 101 predicts a shoot ball, and the prediction comes up, the strike zone changes its color immediately after the ball object is released. Therefore, the batting character can expect the ball to be curved in that direction, which makes it possible to prepare for the batting operation by expecting the movement of the ball object and the time required for the ball object to reach the strike zone 102. In this way, the user operating the batting character 101 can more appreciate the advantage obtained by making the correct prediction. On the other hand, when the pitch type prediction is wrong, the strike zone 102 changes its color to blue at the moment the ball object is released. Thus, the user operating the batting character 101 can recognize that his prediction of the pitch type is wrong. Even when the prediction of the pitch type is wrong, the batting character 100 at least realizes that the next ball is not a shoot ball, and can expect any pitch type other than the shoot ball of all the pitch types the batting character 100 has. Therefore, in this case, even in the case where the prediction of the pitch type is wrong, and the batting character 100 is supposed to have some penalty, some hints are given in a way. (In this case, a disadvantage of having a reduced hit operable time is set). However, the batting character 100 still needs to make a prediction of all the remaining pitch types. Thus, although the user is informed of that his/her pitch type prediction is wrong, this will not after all give him/her a big hint to be advantageous to his/her batting operation.

On the other hand, the user on the batting character side is required to instantly make a preparation for the batting operation in such a short period of time before the ball object reaches the strike zone 102 based on the information on the result (correct/wrong) of the pitch type prediction that can be received immediately after the ball object is released. As a result, the user is required to get into the pitcher-batter matchup with tension and concentration regardless of the result (correct/wrong) of the pitch type prediction. In view of this, it is possible to realize a strong invitation to the game by informing the user of the result of the pitch type prediction immediately after the ball object is released.

In the foregoing, it has been explained such that even when the prediction of the pitch type is wrong, since the batting character 100 needs to make a prediction of the pitch type out of all the remaining pitch types, it does not eventually give him a big hint to an extent that the batting operation can be performed under advantageous condition. However, the following cases are exceptionally considered. Namely, in the case where the pitching character 100 has two pitch types, if the prediction is wrong, the next ball would inevitably be the remaining one pitch type. Thus, the user would recognize the pitch type directly after the ball object is released irrespectively of whether his/her pitch type prediction is correct or not. In view of this, in the described case where the pitching character 100 has two pitch types, it may be designed so as to delay the timing the user is informed of the result (correct/wrong) of the pitch type prediction.

FIG. 5 is an explanatory view of an example in which the informing timing is shifted backwards. In FIG. 5, (a) to (d) respectively show the states where the ball object 107 released by the pitching character 100 approaches the strike zone 102. The hatching lines in the strike zone 102 shown in FIG. 5 indicate the depth of the color subjected to change according to the result (correct/wrong) of the pitch type prediction, and the larger is the number of hatching lines, the deeper is the color. As shown in FIG. 5, the color of the strike zone 102 is gradually changed instead of changing the color immediately after the ball object 107 is released. Specifically, for example, in the case where the prediction of the pitch type is wrong, at the timing immediately after the ball object 107 is released shown in (a) in FIG. 5, the color of the strike zone 102 is still not changed to blue. Then, the color is changed as time passes in the order from the state shown in (b) to the state shown in (d) in FIG. 5 by gradually increasing the percentage of blue color components. For example, when time has passed to the state shown in (b) in FIG. 5, the color of the strike zone 102 is changed to light blue. In this way, a slightly longer time is required for the batting character 101 to recognize the pitch type of the pitched ball (which one of the two pitch types), and for that the time allowed for the preparation of the batting operation will be restricted. Therefore, it is possible to avoid such unreasonable situation that the pitch type can be recognized directly after the ball object 101 is released despite of that the pitch type prediction is wrong. Here, although the recognition of the pitch type is delayed also when the prediction of the pitch type is correct, if the pitching character 101 has only two pitch types, the batting character 100 is only required to prepare for the batting operations corresponding to the two pitch types. Thus, this delay would not be a serious damage. As still another alternative, it may be designed so as to prohibit the pitch type prediction mode when the number of pitch types the pitching character 100 has is small, such as two or three, for example (for example, the pitch type prediction mode is available only in the case where the number of pitch types is four or larger). Specifically, for example, it may be arranged such that in the case where the pitching character has the pitch types of not more than a predetermined number (for example, three), the user operating the batting character 101 is prohibited from making the prediction of the pitch type.

The flow of the foregoing processes is explained referring to the function block diagram of FIG. 6. FIG. 6 is the function block diagram explaining the major functions of the present embodiment, corresponding to a part of the CPU 1 shown in FIG. 1. In the present embodiment, explanations will be given through the case of carrying out an on-line match via the network between the user on the pitching side and the user on the batting side. For the purpose of clarifying the functions of the present invention, the screen seen from the pitching side and the screen seen from the batting side are made to respectively correspond to distinct constituent elements. However, there are some common constituent elements between those of two users, and therefore it is needless to mention that the actual product can be manufactured by making these elements communized. The characteristic feature of the present invention lies in the configurations related to the operations to be performed by the user operating the batting character and the display in the screen on the side of the user operating the batting character. However, hereinafter explanations will be given in order starting from the operations of the user on the pitching side.

First, in a television monitor 21 of the user on the pitching side (hereafter, referred to as a monitor 21), an image when seen from the pitching character 100 is displayed by a first image display section 200 (see FIG. 2). In the screen of the monitor 21, the pitch type selection icon 103 is displayed by a release pattern option display section 201. In a predetermined time after the scene for the pitcher-batter matchup is started, the pitch type selection icon 103 is displayed in the monitor 21, so that the user operating the batting character 101 can consider the pitch type to be pitched against the batting character 101, and can select the pitch type as desired based on the pitch type selection icon 103 by the controller 19. A signal indicative of the pitch type as selected is sent to the release pattern determination section 202, and is also set to the opponent's device (the gaming device 1000 of the user on the batting side) via the network by the information transmission section 203. Here, although the signal indicative of the pitch type is stored in the release pattern determination section 202, the selection of the pitch type can be changed as desired before the throwing motion of the pitching character 100 is started. Thus, the latest data on the pitch type as changed is rewritten in the memory of the release pattern determination section 202. This latest data on the pitch type as changed is transmitted to the opponent's gaming device 1000 via the network by the information transmission section 203.

In the gaming device 1000 of the user on the batting side that is the opponent, the information receiving section 210 receives the data on the pitch type as transmitted via the network from the information transmission section 203 on the pitching side. The data on the pitch type received by this information receiving section 210 on the batting side is stored in the release pattern determination section 202 on the batting side. Namely, the data on the pitch type as selected by the user on the pitching side is stored respectively in the release pattern determination sections 203 of both the pitching side and the batting side.

Here, in the default state, a predetermined pitch type (straight ball, for example) is selected. However, it is not recognized that the prediction on the pitch type is confirmed unless the button for confirming the pitch type is depressed. Moreover, the memory for the data on the pitch type in the release pattern determination section 202 is cleared every time the pitching operation of the pitching character 100 has been completed, to be set back to the initial state (set back to the default state in the case where the default pitch type is set). For each pitching character 100, pitch types are stored in the release pattern storing section 204, and upon selecting the pitching character 100 by the user on the pitching side when starting the game, the data on pitch types of the corresponding pitching character 100 is read out from the release pattern storing section 204 to be transmitted to the release pattern option display section 201. Based on this data on the pitch types, the release pattern option display section 201 performs a display which allows the user to select the pitch type in the monitor 21.

Next, an image seen from the batting character 101 displayed by a second image display section 205 is displayed in the monitor 21 of the user on the batting side (see FIG. 3). The pitch type selection icon 103′ is displayed on the screen seen from the batting character 101 by the release pattern option display section 206 as well as on the screen seen from the pitching character 101. The pitch type selection icon 103′ is a horizontally reversed display of the pitch type selection icon 103. The user on the batting side makes a prediction of the pitch type of the ball to be pitched by the pitching character 100, and selects the pitch type as desired based on the pitch type selection icon 103′ by using the controller 19. A signal indicative of the pitch type as selected is sent to a release pattern prediction section 207, and is also sent to the opponent's device (the gaming device 1000 of the user on the pitching side) via the network by the information transmission section 203. Here, although the signal indicative of the pitch type is stored in the release pattern prediction section 207, the selection of the pitch type can be changed as desired before the throwing motion of the pitching character 100 is started. Thus, the latest data on the pitch type as changed is rewritten in the memory of the release pattern prediction section 207. This latest data on the pitch type as changed is transmitted to the gaming device 1000 of the opponent via the information transmission section 203. In the gaming device 1000 of the user on the pitching side that is the opponent, the information receiving section 210 receives the data on the pitch type as transmitted via the network from the information transmission section 203 on the batting side. The data on the pitch type received by this information receiving part 210 on the pitching side is stored in the release pattern prediction section 207 on the pitching side. Namely, the data on pitch type as predicted by the user on the batting side is stored respectively both in the release pattern prediction sections 207 of the pitching side and the batting side.

Here, the memory for the data on the pitch type in the release pattern prediction section 207 is cleared every time the pitching operation of the pitcher has been completed, to be set back to the initial state (the default state in the case where the default pitch type is set). In the case where the pitch type is not selected, i.e., the user on the batting side does not make a prediction on the pitch type, and the normal pitcher-batter matchup is performed, the memory of the release pattern prediction section 207 remains zero. On the batting side also, for each pitching character 100, the pitch types are stored in the release pattern memory section 204 as in the case of the pitching side, and upon selecting the pitching character 100 by the user on the pitching side when starting the game, the data on pitch types of the corresponding pitching character is read out from the release pattern storing section 204 to be transmitted to the release pattern selection display section 206.

In the above explanations, the pitch type selection to be made by the user on the pitching side and the pitch type prediction to be made by the user on the batting side have been described in this order. In an actual competition, however, this order will be reversed in many cases for the following reason. That is, the time period in which the user on the batting side is permitted to make a selection of the pitch type for the prediction is limited to the time before the pitching character starts the throwing motion, more specifically, the time period after the pitching character confirms the selection on the pitch type before the pitching character starts the throwing motion. Here, this time period is expected to be varied among the users from the long period to the short period, and some users may confirm the selection of the pitch type in short period of time. In that case, if the pitching character starts a pitching operation while the batting character is still making a prediction of the pitch type for the next ball, the batting character will lose an opportunity for confirming the prediction of the pitch type. Therefore, the user operating the batting character is required to make a prediction of the pitch type as quickly as possible. The user on the batting side is further required to perform a batting operation after making the prediction of the pitch type. The user on the batting character side becomes in such a state of mind that the prediction of the pitch type should be confirmed quickly so that he/she can start preparing for the batting operation in an early stage. Therefore, the user on the batting side is expected to make a prediction of the pitch type at an early timing, and therefore it is natural to expect that the batting character confirms the pitch type more quickly than the pitching character confirms the pitch type.

In association with the above, it is possible that the following problem occurs. That is, as described above, the time period in which the user on the batting side is permitted to select the pitch type is limited to the time after the pitching character confirms the selection on the pitch type before the pitching character performs a pitching operation. Thus, if the user on the pitching side with malicious intentions makes a selection on the pitch type at the same time the pitch type selection icon is displayed in the monitor and then starts a pitching operation immediately so as not to provide the user on the batting side with enough time for the selection of the pitch type for the prediction, the user on the batting side will hardly have the time for the selection of the pitch type, and will not be able to use the pitch type prediction mode. In response, in order to avoid the foregoing problem, the following restriction may be added. Namely, in a predetermined time after the pitch type selection icon 103 is displayed in the monitor 21 on the pitching side, the user on the pitching side is permitted to make a consideration on the selection of the pitch type (which one of the lines (pitch types) of the pitch type selection icon 103 is to be selected) but is not permitted to perform an actual pitching operation by the pitching character (namely, the pitch type cannot be confirmed). Here, the predetermined time may be set to one second, for example. According to this configuration, since the minimum time required for the selection of the pitch type for the prediction can be ensured for the batting character, it is possible to avoid such problem that the user on the batting character side cannot use the function of selecting the pitch type for the prediction as being disturbed by the user on the pitching side with malicious intentions.

Referring back to the function diagram of FIG. 6, the present embodiment has the following characteristic functions based on the information on the pitch type thus confirmed on the pitcher (pitching character) side and the predicted pitch type on the batter (batting character) side. A hitting difficulty adjustment section 208 compares the pitch type confirmed on the pitching side stored in the release pattern determination section 202 (the data on pitch type received by the information receiving section 210 on the batting side) with the pitch type predicted on the batting side stored in the release pattern prediction section 207. When the pitch types match, i.e., when the prediction of the pitch type on the batting side is correct, the batting difficulty on the batting side is lowered (as described earlier referring to FIG. 4, in compensation for the correct prediction, the period of time in which the bat object can hit the ball object is set longer). On the other hand, when the pitch types do not match, i.e., when the prediction of the pitch type on the batting side is wrong, the batting difficulty on the batting side is raised (as described earlier referring to FIG. 4, as a penalty, the period of time in which the bat object can hit the ball object is set shorter). If no data on pitch type exist in the release pattern prediction section 207, it is considered that the user on the batting side did not make a prediction of the pitch type, and the batting difficulty is not adjusted.

The prediction result informing section 209 compares the pitch type confirmed on the pitching side stored in the release pattern determination section 202 with the pitch type predicted on the batting side stored in the release pattern prediction section 207. Then, between the case where these pitch types match and the case where they do not match, the color of the strike zone 102 displayed in the monitor 21 is distinguishably changed after the pitching character 100 enters into the throwing motion (for example, red when the prediction of the pitch type is correct, and blue when the prediction is wrong). As described, the user on the batting side can confirm with ease by intuition if his/her prediction of the pitch type is correct. Thus, for example, in the case where the batting character 101 hits the ball object in the batting operation, since the user can recognize that the correct prediction of the pitch type contributes to the hit, he/she is able to progress the game reasonably to his/her satisfaction. Additionally, since the result (correct/wrong) of the prediction is clearly displayed, the user can enjoy the speculative aspect of the game. Furthermore, since the color changes (the user recognizes the prediction of the pitch type is correct) after the pitching character enters into a throwing motion, it becomes possible for the user on the batting side to prepare for the batting operation taking into consideration the result of the prediction, thereby providing the enjoyable aspects of the game which cannot be experienced in the conventional game. When the prediction of the pitch type is correct, it is possible to prepare for a batting operation by expecting the movement, the speed and the like of the pitched ball. Even when the prediction is wrong, the user can at least recognize that the ball to be pitched is not the one he/she predicted, and the user can expect a ball of any of other pitch types excluding the one he/she predicted.

Here, the process of changing the color of the strike zone 102 by the prediction result informing section 209 based on the result (correct/wrong) of the prediction of the pitch type is carried out by the gaming device 1000 on the batting side, in which the screen shown in FIG. 3 is displayed. Namely, the result of the prediction of the pitch type is informed with respect to the user on the batting side who made the prediction of the pitch type. Therefore, it is not necessarily to inform the result of the prediction of the pitch type with respect to the user on the pitching side. However, it is effective to inform the user on the pitching side of the information as to whether the user on the batting side made the prediction of the pitch type, and further the result of the pitch type prediction if the prediction was made on the batting side, in order to make the competition heat up. Namely, the user on the pitching side, who becomes aware of that the pitch type prediction made by the user on the batting side was correct and in reward for the correct prediction, the batting character got a hit), has strong motivation to try not to let the user on the batting side read the pitch type of the next ball. Namely, the user on the pitching side is expected to make a good consideration of the combination of pitch types without casually selecting each pitch type. As a result, the game can be made more interesting and enjoyable. Here, also in the gaming device 1000 on the batting side in which the screen shown in FIG. 2 is displayed, it is preferable that the prediction result informing section 209 executes the informing process of, for example, changing the color of the strike zone 102 according to the result (correct/wrong) of the pitch type prediction.

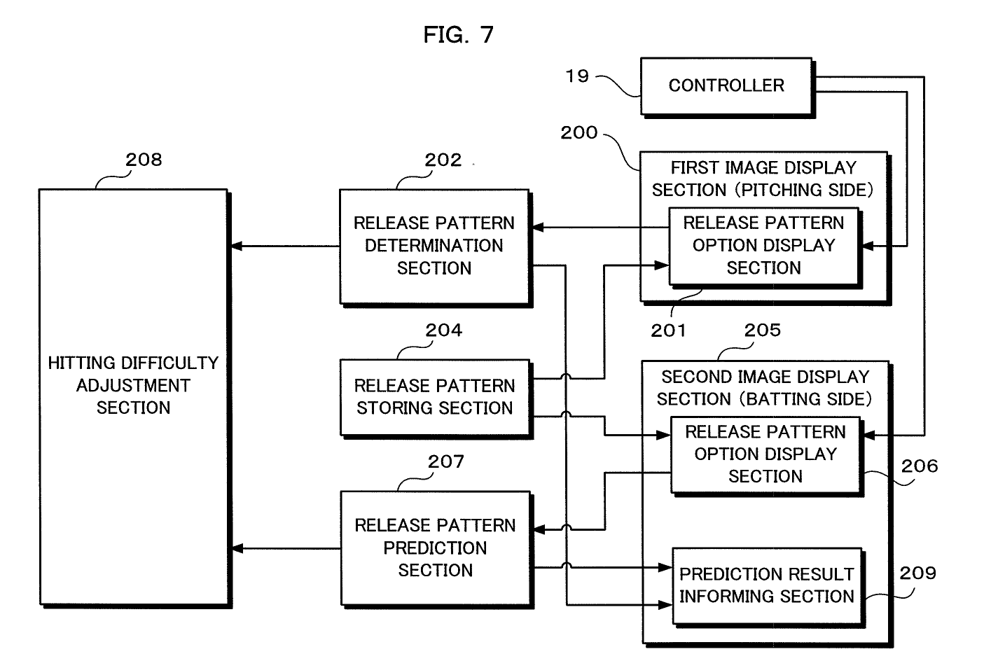

In the example shown in FIG. 6, explanations have been given through the case where the user on the pitching side and the user on the batting side carry out the on-line competition via the network. However, the present embodiment is also applicable to the case where the user alone carries out a CPU competition with the opponent of the CPU. FIG. 7 is a function block diagram of the configuration designed for the CPU competition. The function block diagram of FIG. 7 differs from the function block diagram of FIG. 6 only in that the information transmission section 203 and the information receiving section 210 are omitted because it is not necessary to carry out the transmission and receiving of information with other gaming device in the CPU competition. Incidentally, in the CPU competition, since the user carries out the competition with the opponent of the CPU by alternating the offense side and the defense side, the first image display section 200 on the pitching side and the second image display section 205 on the batting side are provided as in the case of FIG. 6. However, when the user is on the pitching side, i.e., the CPU is on the batting side, the CPU will not make a prediction of the pitch type as a matter of course. Specifically, even if a random prediction of the pitch type is performed on the side of the CPU, the user would not recognize it. Furthermore, the enjoyable aspects of the game from the pitch type prediction are originally appreciated when the user is playing on the batting side. Where the user is on the batting side, and the CPU is on the pitching side, the release pattern determination section 202 automatically selects one pitch type from the pitch types of the pitching character stored in the release pattern storing section 204 and automatically confirms the pitch type to be pitched by the pitching character 100. Here, the release pattern determination section 202 randomly determines the pitch type using a random number generated by a generally used pseudo-random number generation algorithm. Other than the above, the functions of respective members are the same as those shown in FIG. 6, and the explanations thereof shall be omitted here. However, in this example, it is also possible to exhibit the same effects when the user plays the game on the batting side.

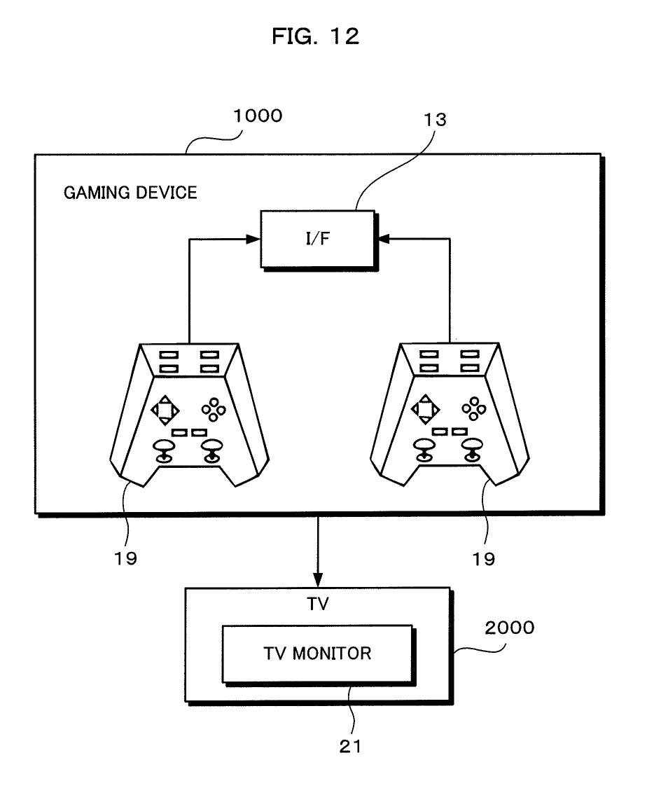

The present embodiment is also applicable to the off-line competition mode in which the off-line competition is carried out between two users. In this example, as shown in FIG. 12, two controllers 19 are connected to one gaming device 1000, so that two users can operate the individual controllers 19 respectively (when one user operates the pitching character, the other user operates the batting character). Then, the users carry out competition while viewing a common screen displayed in one monitor 21. Namely, two users enjoy playing the competitive game while viewing the screen, for example, shown in FIG. 3 together. In this example, however, the pitch type selection icon 103′ which would allow the user to recognize the pitch type selected by the opponent of the user is not displayed.

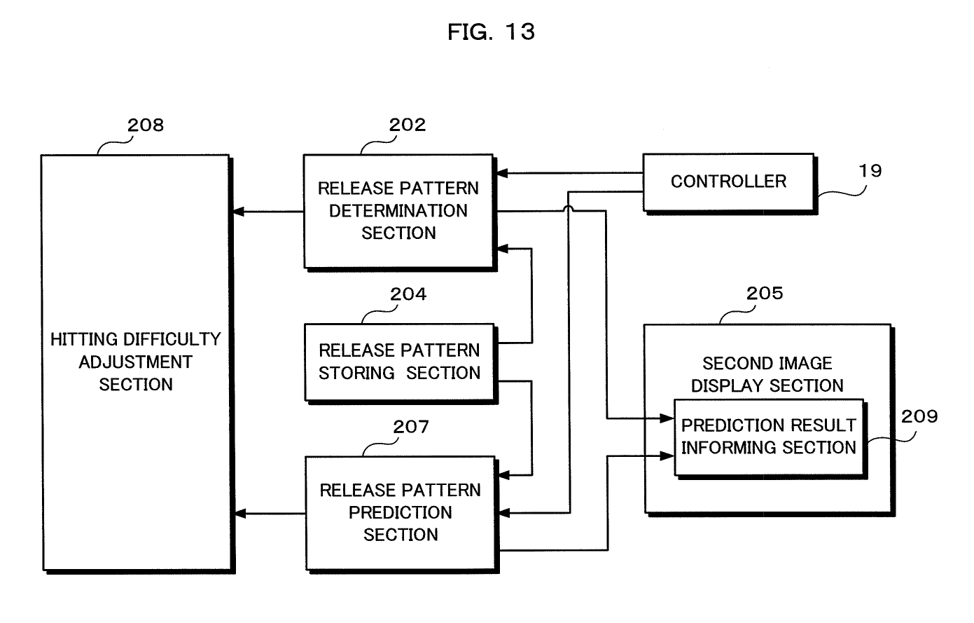

FIG. 13 is a function block diagram of the gaming apparatus in the off-line competition mode. The function block diagram of FIG. 13 differs from the function block diagram of FIG. 6 in that the information transmission section 203 and the information receiving section 210 as well as the first image display section 200 and the release pattern option display sections 201, 206 are not provided. In the off-line competition mode, it is not necessary to neither transmit nor receive information to or from other gaming device. Therefore, the information transmission section 203 and the information receiving section 210 are not needed. Moreover, in the off-line competition mode, the two users carry out competition while viewing the common screen displayed in one monitor 21. Thus, basically, the first image display section 200 is not needed, and only second image display section 205 is necessary. Here, it may be designed so as to divide the display region of the screen in one monitor 21 into two (for example, vertically divided or horizontally divided), and the image of FIG. 2 and the image of FIG. 3 are displayed in divided display regions respectively. In this way, the user on the pitching side plays the game while mainly viewing the image of FIG. 2, and the user on the batting side plays the game while mainly viewing the image of FIG. 3. In this example of displaying images by dividing one screen into two, the first image display section 200 is also included as a constituent element.

Furthermore, in the case of the off-line competition mode, two users carry out a competition while viewing the common screen displayed in one monitor 21. Thus, the information on the selection of the pitch type on the pitching side and the information on the prediction of the pitch type on the batting side should not be displayed. Namely, the pitch type selection icon 103 (103′) should not be displayed on the screen, and the release pattern option display sections 201, 206 are not needed.

In this case, the configuration wherein the pitch type can be selected only by operating the joy stick or buttons, etc., may be adopted without displaying the pitch type selection icon 103′ which allows the user to recognize the pitch type selected by the opponent's user. Specifically, the configuration which permits the user to select the pitch type based on the direction of inclining the joy stick may be adopted. Another configuration may be adopted wherein individual pitch types are allotted to a plurality of buttons (direction keys, and the like), and the pitch type is selected by operating buttons. In the case where the pitching character has four pitch types of a straight ball, a curve ball, a shoot ball, and a fork ball, the operation by the user would not be too difficult by allocating the respective pitch types to the four directions of upper, lower, left and right. However, when the number of the pitch types is larger than the above, it would be difficult to select the pitch type by operating the controller 19. In response, it may be arranged so as to provide a guide display explaining which button of the controller 19 is to be depressed (or to which direction the joy stick is to be inclined) to select which pitch type. Such guide display also serves to inform the users of the number of the pitch types each pitching character has in the case where the respective pitching characters have different number of pitch types.

Therefore, the release pattern determination section 202 of FIG. 13 determines the pitch type based on an input signal from the controller 19 controlled by the user on the pitching side who operates to select the pitch type, without via the release pattern option display section, and stores the data on the pitch type. The release pattern prediction section 207 determines the pitch type for the prediction based on an input signal from the controller 19 controlled by the user on the batting side who operates to select the pitch type for the prediction without via the release pattern option display section, and stores the data on the predicted pitch type.

Other than the above, the functions of respective members are the same as those shown in FIG. 6, and the explanations thereof shall be omitted here. However, in this example shown in FIG. 13, the same effects as achieved from the configuration shown in FIG. 6 can be exhibited when the user plays the game on the batting side.

In the foregoing, explanations have been given individually for the on-line mode (including communication competition mode such as ad hoc mode, etc.) wherein two users carry out the competition via the network shown in FIG. 6, the CPU competition mode shown in FIG. 7, and the off-line competition mode of FIG. 13. However, the gaming device may be arranged so as to include all these three modes, or any two of them.

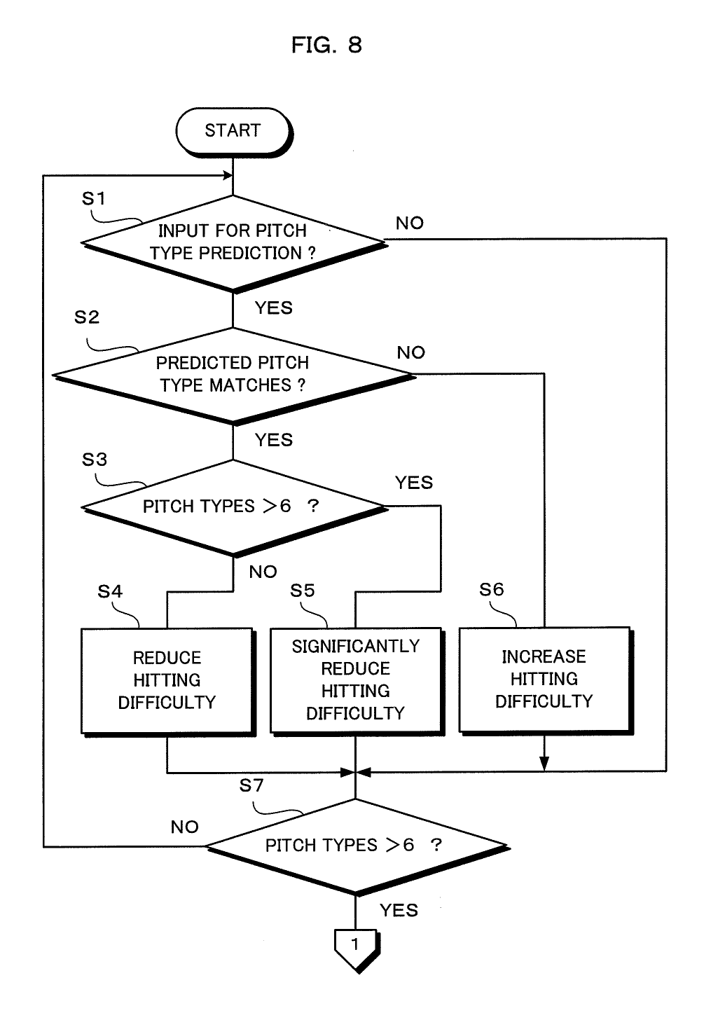

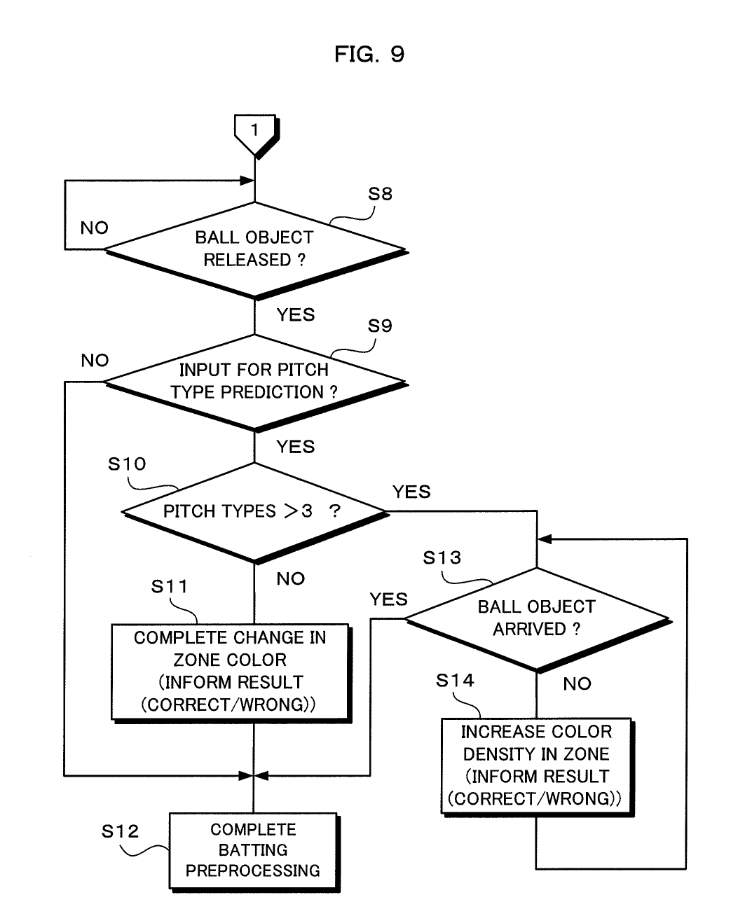

FIG. 8 and FIG. 9 are flowcharts showing the processes in which the prediction of the pitch type of the user (batting character) on the batting side and the result of the pitch type prediction affect the batting operation. In the following, explanations will be given step by step in reference to the game screen of FIG. 3 and the block diagram of FIG. 6 as necessary. These flowcharts show the state in the period from the timing just before the pitching character of the opponent enters into a throwing motion to the timing just before the batting character starts a batting operation.

Firstly, the user operating the batting character 101 is allowed to select one pitch type from the pitch type selection icon 103′ which he/she predicts for the next ball to be pitched only in the limited time period before the pitching character 100 enters into the throwing motion. In this selectable period of the pitch type prediction, it is determined if an input is made for the pitch type prediction by the user on the batting side (STEP S1). When the input is made for the pitch type prediction (YES in STEP S1), it is determined if the predicted pitch type matches the pitch type selected by the pitching character (STEP S2). When they are determined to be matched (YES in STEP S2), the hitting difficulty on the batting side is reduced (to make it easier for the batting character to get a hit). Here, the hitting ratio of the pitch type prediction is taken into consideration. That is, depending on the number of the pitch types the pitching character has, the degree of reduction in the batting difficulty is changed when the pitch type prediction comes up. Specifically, the larger is the number of the pitch types the pitching character has, the more difficult is to make a correct prediction. Therefore, the larger is the number of the pitch types, the greater is the advantage the user on the batting side obtains for the correct prediction. Specifically, it is determined if the number of the pitch types the pitching character has is seven or larger (STEP S3). If the number of the pitch types is less than seven (NO in STEP S3), the hitting difficulty is reduced (STEP 5). On the other hand, when the number of pitch types is seven or larger (YES in STEP S3), the hitting difficulty is reduced to a larger extent (STEP S5). Specifically, the hit operable time is changed as described earlier referring to FIG. 4, which is usually the period of four frames. Specifically, if NO in STEP S3, the hit operable time is increased to six frames in STEP S4. On the other hand, if YES in STEP S3, the hit operable time is further increased to eight frames in STEP 5.

Referring back to STEP S2, when the pitch type predicted by the batting character does not match the pitch type selected by the pitching character (NO in STEP S2), the hitting difficulty is increased (to make it more difficult for the batting character to get a hit) (STEP S6). Specifically, as described earlier referring to FIG. 4, the hit operable time which is usually the period of four frames is reduced to two frames in STEP S6. Here, the process for the batting operation is not included in this flowchart, and the processes in STEPS S4 to S6 are the preprocessing of the data to be used in the batting operation by the batting character.

After carrying out the process in STEP S4 to S6, it is determined if the pitching character has started the pitching motion (STEP S7). When it is determined that an input is not made for the pitch type prediction (NO in STEP S1), the sequence goes to this determination process in STEP S7. If the pitching motion has not started (NO in STEP S7), the sequence goes back to STEP S1. Namely, it is designed such that the pitch type for the prediction can be changed any time before the pitching motion starts as described earlier. Even in the case where the user initially does not intend to make a prediction of the pitch type, he/she may suddenly change his/her mind to make a selection for the pitch type prediction. With this configuration, the user operating the batting character is permitted to make a selection of the pitch type for the prediction any time before the throwing motion is started.

Referring now to FIG. 9, it is determined if the ball object has been released (STEP S8). After the pitching character enters into the throwing motion before the ball object is released, a change in the strike zone, i.e., the characteristic feature of the present embodiment is not made, and thus it is set in the wait state for the next process (NO in STEP S8). When the ball object is released by the pitching character, the color of the strike zone is changed so as to indicate the result (correct/wrong) of the pitch type prediction, provided that the pitch type prediction has been made on the batting side. Thus, the following processes are performed. When the ball object is released (YES in STEP S8), it is determined if an input is made for the pitch type prediction (STEP S9). If the input is made for the pitch type prediction (YES in STEP S9), it is determined if the pitching character has three or more pitch types (STEP S10). If the pitching character has three or more pitch types (NO in STEP S10), the color of the strike zone is changed (STEP S11). Though the result (correct/wrong) of the pitch type prediction is determined also in STEP S2, for example, the color of the strike zone is changed to blue when the pitch type prediction is correct, while the color of the strike zone is changed to red when the pitch type prediction is wrong. Then, the preprocessing of the batting process on the batting side has been completed (STEP S12). Subsequently, the batting process is performed.

On the other hand, in the case where the pitch type prediction is made on the batting side, and the corresponding pitching character has two pitch types (YES in STEP S10), the color of the strike zone is changed but in different manner. That is, the color is changed but gradually until the ball object arrives at above the home plate at the batting character (while the ball object approaches the hit operable region by the batting character). Namely, while the ball object has not reached at above the home plate at the batting character (NO in STEP S13), the process of increasing the color density of the strike zone (STEP S14) is repeated. As explained earlier, for example, in the case where the pitching character has only two pitch types, even if the pitch type prediction made by the batting side is wrong, the user on the batting side will see the pitch type selected on the pitching side at the moment the ball object is released. In consideration of this, the determination on the prediction result is made slightly less recognizable to make a balance between the batting side and the pitching side by avoiding the one-sidedly advantageous situation to the batting side when the number of the pitch types is as small as two. Then, when the ball object has arrived at around the position above the home plate (YES in STEP 513), the preprocessing of the batting process is completed (STEP S12).

Although the foregoing embodiment has been explained through the case of the baseball game, the present embodiment is applicable to any game in which a competition is carried out between a personified character delivering a flying object and a personified character hitting back the flying object, such as a softball game, a tennis game, a table tennis game, and the like.

Furthermore, various types of characters can be made appear in the game, and the personified character includes those of animals, fictitious living things (monster, etc.), robots, expressed in the similar manner as human being.

In the foregoing, explanations have been given through the example in which the prediction result informing section 209 informs the user of the result (correct/wrong) of the pitch type prediction by changing the color of the strike zone 102. However, the present embodiment is not limited to this example, and the result may be informed, for example, by the following configurations.

The color of other region or object than the strike zone 102 in the screen may be changed between the case where the pitch type prediction is correct and the case where the pitch type prediction is wrong. Here, other region or object can be, for example, the ball object released by the pitching character, the bat object of the batting character, the meet cursor, the home plate, or the like. Alternatively, an exclusive object may be displayed in the screen, for informing the user of the result (correct/wrong) of the pitch type prediction, and the result may be informed by changing the color of this exclusive object. Namely, any configuration of changing the color of at least a part of the screen between the case where the pitch type prediction is correct and the case where the pitch type prediction is wrong may be adopted. In relation to the configuration of changing the color, any of the three attributes of color, i.e., hue, brightness and saturation may be changed.

In particular, the following effect can be exhibited from the configuration of informing the result by changing the color of the ball object released by the pitching character. That is, in the screen of FIG. 3 an image is displayed that allows the user to visually recognize the pitching character's direction from the batting character, the size (display area) of the ball object released by the batting character gradually increases as it approaches the hit operable region (see FIG. 5). Therefore, even when the display color of the ball released by the pitching character is changed at a predetermined density directly after the ball object is released, at first, i.e., directly after the ball object is released, the display size of the ball is small. In this state, it is therefore relatively difficult to recognize the color of the ball. Then, as the ball approaches the hit operable region, the display size of the ball object becomes larger, and the color of the ball object becomes clearer. With this configuration, as the ball approaches the hit operable region, the same effect can be exhibited as exhibited from the configuration of gradually increasing the density of the color of the strike zone 102.

Furthermore, when performing the batting operation, the user operating the batting character tends to fix his/her eyes on the ball object released by the pitching character. Thus, according to the configuration of informing the result (correct/wrong) of the pitch type prediction by changing the color of the ball object, an additional effect that the user is able to recognize the result of the pitch type prediction while keeping his/her eyes on the ball object in the batting operation.

In order to clearly inform the user of the information on the result (correct/wrong) of the pitch type prediction, the example has been explained in which even when the pitch type prediction is wrong, the color of the strike zone 102 is changed from the original color (the color when the pitch type prediction is not made) of the strike zone 102 (for example, red when the pitch type prediction is correct, and blue when the pitch type prediction is wrong). However, it may be designed that the color of the strike zone 102 is changed only when the pitch type prediction is correct. With this configuration, the user who made the pitch type prediction can recognize that the pitch type prediction is correct when the color of the strike zone 102 is changed after the ball object is released by the pitching character, and that the pitch type prediction is wrong when the color of the strike zone has not been changed after the ball object is released by the pitching character. This example is considered to be one example that falls under the configuration of changing the color of at least a part of the screen between the case where the pitch type prediction is correct and the case where the pitch type prediction is wrong. Alternatively, it may be also designed that the color of the strike zone 102 is changed only when the pitch type prediction is wrong.

In particular, according to the configuration wherein the color of the strike zone 102 is changed only when the pitch type prediction is correct, it can be understood such that the user is immediately informed of the result when the pitch type prediction is correct, while the user is informed of the result when the pitch type prediction is wrong at a later timing than the case where the prediction is correct. Namely, a human brain is able to quickly identify a change in color (change in wavelength in the visible light region). Therefore, when the pitch type prediction is correct, the user recognizes it by intuition by directly confirming by sight the change in color of the strike zone 102.

On the other hand, it is considered it takes some time for the human brain to recognize that the color has not changed. Therefore, in the case where the pitch type prediction is wrong, since there is a slight time lag for the user to recognize that the color has not changed, for this slight time lag, the user's recognition of the wrong prediction is expected to be delayed without recognizing the wrong prediction of the pitch type by intuition direct after the ball object is released by the pitching character. Although the delay in the recognition of the wrong prediction is merely a slight delay, in consideration of that the time period itself from the timing the ball object is released by the pitching character to the timing the ball arrives at the hit operable region is so short, the delay is merely a slight delay yet still affect the user's preparation of the batting operation.

Therefore, in the case where the pitch type prediction is correct, the user is able to perform a preparation of the batting operation more advantageously over the case where the pitch type prediction is wrong. Therefore, according to the configuration wherein the color of the strike zone 102 changes directly after the ball object is released by the pitching character only when the pitch type prediction is correct, the same effect can be exhibited as the effect exhibited from the configuration wherein the timing of informing the result of the pitch type prediction is delayed only when the prediction is wrong while maintaining the advantage obtained when the pitch type prediction is correct. This configuration is particularly suitable, for example, in the case where the number of the pitch types the pitching character has is not larger than the predetermined number (as small as two pitch types, in particular).

Moreover, the prediction result informing section 209 may be designed so as to inform the result (correct/wrong) of the pitch type prediction with sound effects without displaying the result in the screen. For example, effective sounds, that are different between the case where the pitch type prediction is correct and the case where the pitch type correction is wrong, may be generated directly after the ball object is released by the pitching character.

Alternatively, it may be designed such that sound effects are generated only when the pitch type prediction is correct (or only when the pitch type prediction is wrong). As described, for the pitch type prediction informing section 209, any configuration may be adopted as long as the user is informed of the result of the pitch type prediction directly after the ball object is released using different conditions between the case where the pitch type prediction is correct and the case where the pitch type prediction is wrong.

Moreover, although the foregoing explanations have been given through the case of performing an input operation of the gaming device by the user using the joy stick and the buttons, etc. of the controller 19, the present invention is not intended to be limited to this. For example, for gaming devices, portable phones, smart phones, PDAs, tablet computers, etc., integrally provided with monitors, there are those provided with a touch panel (interface of the contact input type). In the gaming devices provided with such touch panel, the user is able to perform an input operation of the gaming device by making his/her finger or a pen contact the touch panel.

### Main Features of the Embodiments

The invention having the following features is mainly included in the above-described specific embodiments.

1) A gaming device according to one aspect of the invention which executes a competition wherein a flying object released by a first personified character is hit back by a second personified character, includes an image display section for displaying an image perceived in a direction from the second personified character to the first personified character; a release pattern storing section for storing a plurality of release patterns, each defining a movement of the flying object to be released by the first personified character; a release pattern option display section for displaying the release patterns stored in the release pattern storing section in the screen as selectable release pattern options; a release pattern determination section for determining a release pattern of the flying object by the first personified character by selecting one of the release patterns stored in the release pattern storing section; a release pattern prediction section for determining a prediction release pattern for the release pattern of the flying object to be released by the first personified character by selecting one of the plurality of release patterns stored in the release pattern storing section based on a selecting operation by a user with respect to the selectable release pattern options; and a difficulty adjustment section for adjusting a difficulty for the second personified character to hit back the flying object released by the first personified character, the difficulty adjustment section comparing the release pattern determined by the release pattern determination section with the prediction release pattern determined by the release pattern prediction section, and reducing the difficulty when the release pattern determined by the release pattern determination section and the prediction release pattern determined by the release pattern determination section match, to be lower than the difficulty in the case where the user operating the second personified character does not select the prediction release pattern.

A game control program according to another aspect of the present invention which executes a competition wherein a flying object released by a first personified character is hit back by a second personified character, for causing a computer to function as an image display section for displaying an image perceived in a direction from the second personified character to the first personified character; a release pattern storing section for storing a plurality of release patterns, each defining a movement of the flying object to be released by the first personified character; a release pattern option display section for displaying the release patterns stored in the release pattern storing section in the screen as selectable release pattern options; a release pattern determination section for determining a release pattern of the flying object by the first personified character by selecting one of the release patterns stored in the release pattern storing section; a release pattern prediction section for determining a prediction release pattern for the release pattern of the flying object to be released by the first personified character by selecting one of the plurality of release patterns stored in the release pattern storing section based on a selecting operation by a user with respect to the selectable release pattern options; and a difficulty adjustment section for adjusting a difficulty for the second personified character to hit back the flying object released by the first personified character, the difficulty adjustment section comparing the release pattern determined by the release pattern determination section with the prediction release pattern determined by the release pattern prediction section, and reducing the difficulty when the release pattern determined by the release pattern determination section and the prediction release pattern determined by the release pattern determination section match, to be lower than the difficulty in the case where the user operating the second personified character does not select the prediction release pattern. A recording medium according to still another aspect of the present invention is a computer readable recording medium recorded with the game control program.

The foregoing configuration is described by taking a pitcher-batter matchup in a baseball game as an example. When a ball object (flying object) pitched by a pitching character (first character) is hit back by operating a batting character (second character), the user makes a prediction of the pitch type of the ball (release pattern) beforehand.

Specifically user selects the pitch type (determines the prediction release pattern) (for example, one of Curve, Shoot, Strait, Slider, etc.,) of the next ball to be pitched from the pitch type selection icon (release pattern options) displayed in the game screen. Then, when the prediction is correct, the difficulty for the batting character to hit back the ball object is reduced as compared to the case where the pitch type prediction is not made (when swinging the bat, hitting the ball becomes easier). With this configuration, a novel function of predicting the pitch type which cannot be realized by the conventional game can be realized, thereby providing a realistic game by reflecting therein the tactics, for example, in the pitcher-batter matchup in a baseball in the real world.

The foregoing configuration 1) is applicable to any of the CPU competition mode, the mode in which two users perform an on-line competition, and the mode in which two users perform an off-line competition.

In the application of the CPU competition mode, it can be designed such that the release pattern determination section automatically selects one release pattern from the plurality of release patterns stored in the release pattern storing section to be determined as the release pattern of the flying object by the first character. On the other hand, in the application of the mode in which two users perform an on-line competition or the mode in which two users perform an off-line competition, it can be designed such that the release pattern determination section selects one release pattern from the plurality of release patterns stored in the release pattern storing section based on the selection operation by the user operating the first character, to be determined as the release pattern of the flying object by the first character.

2) It is preferable that the difficulty adjustment section further adjusts the difficulty for the second personified character to hit back the flying object released by the first personified character to be higher when the release pattern determined by the release pattern determination section and the prediction release pattern determined by the release pattern determination section do not match than the difficulty in a case where a prediction of the release pattern is not made.

In addition to the configuration 1), the foregoing configuration is, for example, in the pitcher-batter matchup in the baseball game, further designed so as to increase the difficulty in hitting back the ball object when the user's prediction of the pitch type is wrong (when swinging the bat, hitting the ball object becomes more difficult). Therefore, when the pitch type prediction is made, and the prediction successfully comes up, hitting the ball back becomes easier. On the contrary, when the pitch type prediction is wrong, hitting the ball back becomes more difficult as a kind of penalty. According to this configuration, making a pitch type prediction is not always advantageous to the batting character (user) but can be disadvantageous depending on the result of the prediction. Therefore, it is possible to carry out the competition with good concentration while feeling a sense of tension.

3) It is preferable that the difficulty adjustment section adjusts a hit operable time defining a timing at which the flying object can be hit when the second personified character performs an operation of hitting back the flying object released by the first personified character; and when the release pattern determined by the release pattern determination section and the prediction release pattern determined by the release pattern determination section match, the difficulty adjustment section sets the hit operable time to a first hit operable time which is longer than a hit operable time set in a case where the prediction release pattern is not selected by the second personified character, while when the release pattern determined by the release pattern determination section and the prediction release pattern determined by the release pattern determination section do not match, sets the hit operable time to a second hit operable time which is shorter than the hit operable time set in the case where the prediction release pattern is not selected.

According to the foregoing configuration, for example, in the pitcher-batter matchup in the baseball game, when the pitch type prediction made by the batting character (user) is correct, the hit operable time, in which when swinging the bat, the bat can be hit by the bat, is set longer than the hit operable time set in the case where the pitch type is not selected. On the contrary, when the pitch type prediction is wrong, the hit operable time is set shorter than the hit operable time set in the case where the pitch type is not selected. Here, the hit operable time is defined to be a predetermined time in which the ball passes the area above or in a vicinity of the home base, which is set in a time period from the timing at which the ball is released by the pitching character to the timing at which the ball arrives at around the batting character. It is designed that the ball can be hit by the bat when a swing is made in the above predetermined time set for the hit operable time. It is further designed that when the ball is hit by the bat in the middle of this predetermined period, the ball object flies straight, i.e., towards the center field. On the other hand, when the ball is hit before the above timing, the hit would be a so-called hit pulling the ball object. On the contrary, when the ball is hit at timing later than the middle of the predetermined time period, the hit would be a so-called a hit in an opposite way. This predetermined time period may be set, for example, to four frames (1 frame: 1/60 second) provided that the time period, from the timing at which the ball is released by the pitching character to the timing at which the ball arrives at around the batting character, be 30 frames. Then, when the pitch type prediction made by the batting character (user) is correct, this hit operable time is increased from four frames to six frames. On the contrary, when the pitch type prediction is wrong, the hit operable time is reduced to two frames. When the bat is swung in outside each hit operable time, the ball is missed. Here, since the speed of a pitched ball is changed for each pitch, it may be designed to precisely change the hit operable time for each pitch. However, it is unlikely that the speed of the pitched ball differs by three, five times even in view of the real baseball game (for example, the speed of the pitched ball cannot be 300 Km/hr). Therefore, it should not be a problem to have a fixed hit operable time irrespectively of the speed of the pitched ball. It is preferable to have the fixed hit operable time also in terms of suppressing the processing load.

4) It is preferable that the larger is the number of options displayed in the release pattern option display section, the longer are the first hit operable time set when the release pattern determined by the release pattern determination section and the prediction release pattern determined by the release pattern determination section match and the second hit operable time set when the release pattern determined by the release pattern determination section and the prediction release pattern determined by the release pattern determination section do not match respectively set by the difficulty adjustment section.

The foregoing configuration is designed in view of the fact that the larger is the number of the pitch types of the pitch type selection icon (release pattern options), the more difficult is for the pitching character (use) to make a correct prediction for the next ball to be pitched. Therefore, the larger is the number of the pitch types, the longer hit operable time is set (the greater is the advantage the user on the batting side obtains) for the correct prediction. Moreover, even when the prediction is wrong, it is originally difficult to make a correct prediction with respect to a larger number of pitch types. In view of this, when the number of the pitch types is large, it is designed to reduce the hit operable time to a small extent even when the pitch type correction is wrong (the penalty element is suppressed without reducing the hit operable time to a large extent). As a result, it is possible to suppress the sense of unfairness between users even when there are differences in the number of the pitch types the pitching characters have among the pitching characters. Specifically, in the application of the on-line competitive baseball game, for example, the following condition is possible. That is the number of the pitch types of the pitching character used by user A when he/she plays a game on the defense side is three, while the number of the pitch types of the pitching character used by user B when he/she plays the game on the defense side is six. In this case, it is apparently more difficult for the user A to make a pitch type prediction for the opponent's pitcher than for the user B to make a pitch type prediction for the opponent's pitcher. Therefore, there arises a difference in difficulty in the operability between the user A and the user B, and since one side becomes advantageous, resulting in that the game balance is biased to one side. However, by designing such that when the pitch type prediction is difficult due to a large number of the pitch types the opponent's pitcher has, the greater effect the user operating the batting character can be obtained when the prediction is correct. As a result, it is possible to realize a game having overall well-balanced computing abilities by avoiding the one-sidedly advantageous situation to the user operating the pitching character having a larger number of pitch types.

5) It is preferable that a prediction result informing section is further provided, which compares the release pattern determined by the release pattern determination section with the prediction release pattern determined by the release pattern prediction section, and informs the user of a result of the prediction directly after the flying object is released by the first character in different manners between the case where the release pattern determined by the release pattern determination section and the prediction release pattern determined by the release pattern determination section match and the case where the release pattern determined by the release pattern determination section and the prediction release pattern determined by the release pattern determination section do not match.

According to the foregoing configuration, the user is informed of the result of the prediction in different manners between the case where the pitch type prediction is correct (the release pattern determined by the release pattern determination section and the prediction release pattern determined by the release pattern determination section match) and the case where the pitch type correction is wrong (the release pattern determined by the release pattern determination section and the prediction release pattern determined by the release pattern determination section do not match). Moreover, the user is informed of the result directly after the ball object (flying object) is released by the pitching character (first character). With this configuration, the batting character (user) is expected to adjust his/her batting operation instantly according to the result (correct/wrong) of his/her pitch type prediction, thereby realizing a game bringing a sense of tension. For example, in the case where the batting character predicts the pitch type of the next ball to be Shoot, and he/she is informed of that his/her prediction is correct directly after the ball is released, the batting character is only required to perform a batting operation by expecting the movement, speed and the arrival timing for the Shoot ball which will move as predicted. On the other hand, in the case where the batting character is informed of that his/her prediction is wrong, he/she will at least recognize that the movement of the next ball will not follow the course of the Shoot ball. Thus, the batting character can prepared for the batting operation expecting other pitch types the pitching character has. The foregoing determination and the operation are required to perform in such a short period of time from the timing at which the ball is released to the timing at which the ball arrives in a vicinity of the home plate. Namely, the user is required to make an instantaneous decision, thereby realizing a highly enjoyable game accompanied by a sense of tension.

6) It is preferable that the different manners are in relation to the colors for at least a part of a screen, and the color density is gradually increased as the flying object approaches the hit operable region in which the flying object can be hit by the second character.

According to the foregoing configuration, a problem which may arise in the case where the pitching character has a small number of pitch types associated in the configuration 5) can be solved. Specifically, for example, in the case where the pitching character has only two pitch types, i.e., Straight and Shoot, if the pitch type prediction is wrong, the determined pitch type is inevitably the remaining one pitch type. Therefore, the user operating the bating character can recognize the pitch type of the next ball irrespectively of the result (correct/wrong) of the pitch type prediction. In view of the foregoing, provided that, for example, the color of the strike zone is changed to red when the prediction is correct, and changed to blue when the prediction is wrong, it is designed so as to set the respective colors of the strike zone to change but in light colors directly after the ball is released, and then the color densities are increased gradually as the ball approaches at above the home plate. With this configuration, directly after the ball is released, the batting character is difficult to recognize the result (correct/wrong) of the prediction. Then, as the time passes, the batting character becomes able to recognize the result (correct/wrong) of the prediction. On the other hand, as the time passes, the batting character has more limited time left for the preparation of the bat swinging operation. Therefore, it is difficult for the batting character to change the batting operation directly after changing the pitch type. As a result, it is possible to realize a well-balanced difficulty in the entire game. This configuration is particularly preferable in the case where the number of the pitch type of the pitching character is small, specifically three pitch types or only two types.

7) A gaming device according to yet another aspect of the present invention, which executes a competition wherein a flying object released by a first personified character is hit back by a second personified character while communicating between two gaming devices, comprising: a first image display section for displaying an image perceived in a direction from the first personified character to the second personified character when the first user operates the first personified character; a second image display section for displaying an image perceived in a direction from the second personified character to the first personified character when the second user operates the second personified character; a release pattern storing section for storing a plurality of release patterns, each defining a movement of the flying object to be released by the first personified character; a release pattern indicator display section for displaying a release pattern indicator in a game screen in a manner that the release patterns stored in the release pattern storing section are selectable; a release pattern determination section for determining a release pattern of the flying object by the first personified character by selecting one of the release patterns stored in the release pattern storing section when the first user operates the first character; a release pattern prediction section for determining a prediction release pattern for the release pattern of the flying object to be released by the first personified character by selecting one of the plurality of release patterns stored in the release pattern storing section when the second user operates the second character; and a difficulty adjustment section for adjusting a difficulty for the second personified character to hit back the flying object released by the first personified character, the difficulty adjustment section comparing the release pattern determined by the release pattern determination section with the release pattern determined by the release pattern prediction section, and reducing the difficulty when the release pattern determined by the release pattern determination section and the prediction release pattern determined by the release pattern determination section match to be lower than the difficulty in the case where the second user does not select the prediction release pattern.

The foregoing configuration is basically the same as the configuration 1), but limited to the competition between users. Namely, the pitching character (first character) is operated by the human (first user), and the batting character (second character) is also operated by the human (second user). In contrast, the configuration 1) covers the so-called CPU competition in which the pitching character is operated by the CPU. The essential feature of this configuration lies in the pitch type prediction to be made by the batting character (the user operating the batting character). The subject matter on the pitching character of this configuration is similar to those of the conventional game. In this configuration, however, provided that the pitching character (the user operating the pitching character) is expected to set a combination of pitch types in consideration of the possibility of the pitch type prediction of the opponent (batting character). As a result, both the pitching side and the batting side try to read the opponents' tactics one another, thereby providing a highly enjoyable game.

Embodiments of the present invention relate to a gaming device, a game control method, a game control program, and a computer readable recording medium recorded with the game control program, which virtually reflects in the game the difficulty for the character to hit back the flying object to perform an operation of hitting the flying object in the competition wherein the flying object released by the first personified character is hit back by the second personified character.

According to the embodiment of the present invention, for example, in the case of a baseball game, the batting character makes a prediction on the pitch type of the ball to be pitched by the pitching character, and according to the result (correct/wrong) of the pitch type prediction, the difficulty of the batting operation is changed, which cannot be experienced in the conventional game. The present invention is applicable to tennis game, table tennis game, and the like other than the baseball game.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions.

What is claimed is:

1. A gaming device which executes a competition wherein a flying object released by a first personified character is hit back by a second personified character, comprising:
an image display section for displaying an image perceived in a direction from the second personified character to the first personified character;
a release pattern storing section for storing a plurality of release patterns, each defining a movement of the flying object to be released by the first personified character;
a release pattern option display section for displaying the release patterns stored in the release pattern storing section in the screen as selectable release pattern options;
a release pattern determination section for determining a release pattern of the flying object by the first personified character by selecting one of the release patterns stored in the release pattern storing section;
a release pattern prediction section for determining a prediction release pattern for the release pattern of the flying object to be released by the first personified character by selecting one of the plurality of release patterns stored in the release pattern storing section based on a selecting operation by a user with respect to the selectable release pattern options; and
a difficulty adjustment section for adjusting a difficulty for the second personified character to hit back the flying object released by the first personified character, said difficulty adjustment section comparing the release pattern determined by the release pattern determination section with the prediction release pattern determined by the release pattern prediction section, and reducing the difficulty when the release pattern determined by the release pattern determination section and the prediction release pattern determined by the release pattern determination section match, to be lower than the difficulty in the case where the user operating the second personified character does not select the prediction release pattern.

2. The gaming device according to claim 1, wherein:
said difficulty adjustment section further adjusts the difficulty for the second personified character to hit back the flying object released by the first personified character to be higher when the release pattern determined by the release pattern determination section and the prediction release pattern determined by the release pattern determination section do not match than the difficulty in a case where a prediction of the release pattern is not made.

3. The gaming device according to claim 2, wherein:
the difficulty adjustment section adjusts a hit operable time defining a timing at which the flying object can be hit when the second personified character performs an operation of hitting back the flying object released by the first personified character; and
when the release pattern determined by the release pattern determination section and the prediction release pattern determined by the release pattern determination section match, the difficulty adjustment section sets the hit operable time to a first hit operable time which is longer than a hit operable time set in a case where the prediction release pattern is not selected by the second personified character, while when the release pattern determined by the release pattern determination section and the prediction release pattern determined by the release pattern determination section do not match, sets the hit operable time to a second hit operable time which is shorter than the hit operable time set in the case where the prediction release pattern is not selected by the second personified character.

4. The gaming device according to claim 3, wherein:
the larger is the number of options displayed in the release pattern option display section, the longer are the first hit operable time set when the release pattern determined by the release pattern determination section and the prediction release pattern determined by the release pattern determination section match and the second hit operable time set when the release pattern determined by the release pattern determination section and the prediction release pattern determined by the release pattern determination section do not match respectively set by the difficulty adjustment section.

5. The gaming device according to claim 2, further comprising:
a prediction result informing section, which compares the release pattern determined by the release pattern determination section with the prediction release pattern determined by the release pattern prediction section, and informs the user of a result of the prediction directly after the flying object is released by the first character in different manners between the case where the release pattern determined by the release pattern determination section and the prediction release pattern determined by the release pattern determination section match and the case where the release pattern determined by the release pattern determination section and the prediction release pattern determined by the release pattern determination section do not match.

6. The gaming device according to claim 5, wherein:
said prediction result informing section informs the user of the result of the prediction in different manners by using different colors for at least a part of a screen displayed by the image display means between the case where the release pattern determined by the release pattern determination section and the prediction release pattern determined by the release pattern determination section match and the case where the release pattern determined by the release pattern determination section and the prediction release pattern determined by the release pattern determination section do not match, and gradually increases a color density of at least the part of the screen after the flying object is released by the first personified character as the flying object approaches the hit operable region in which the flying object can be hit by the second personified character.

7. The gaming device according to claim 1, further comprising:
a release pattern option display section for displaying the release patterns stored in the release pattern storing section in the screen displayed by the image display section as options for release patterns selectable by an operation of the user.

8. The gaming device according to claim 1, wherein:
said release pattern determination section automatically selects one release pattern from the plurality of release patterns stored in the release pattern storing section to be determined as the release pattern of the flying object to be released by the first personified character.

9. The gaming device according to claim 1, wherein:
said release pattern determination section selects one release pattern from the plurality of release patterns stored in the release pattern storing section based on a selection operation by the user operating the first personified character to be determined as the release pattern of the flying object to be released by the first personified character.

10. A gaming device which executes a competition wherein a flying object released by a first personified character is hit back by a second personified character while communicating between two gaming devices, comprising:
a first image display section for displaying an image perceived in a direction from the first personified character to the second personified character when the first user operates the first personified character;
a second image display section for displaying an image perceived in a direction from the second personified character to the first personified character when the second user operates the second personified character;
a release pattern storing section for storing a plurality of release patterns, each defining a movement of the flying object to be released by the first personified character;
a release pattern indicator display section for displaying a release pattern indicator in a game screen in a manner that the release patterns stored in the release pattern storing section are selectable;
a release pattern determination section for selecting one release pattern from the plurality of release patterns stored in the release pattern memory means based on a selecting operation by the first user, to be determined as the release pattern of the flying object to be released by the first personified character;
an information transmitting section for transmitting the release pattern determined by the release pattern determination section to an opponent's gaming device;
an information receiving section for receiving the release pattern transmitted by the information transmitting section from an opponent's gaming device;
a release pattern prediction section for determining a prediction pattern for the release pattern of the flying object to be released by the first personified character by selecting one of the plurality of release patterns stored in the release pattern storing section based on a selecting operation by the second user; and
a difficulty adjustment section for adjusting a difficulty for the second personified character to hit back the flying object released by the first personified character, said difficulty adjustment section comparing the release pattern determined by the release pattern determination section with the release pattern determined by the release pattern prediction section, and reducing the difficulty when the release pattern determined by the release pattern determination section and the prediction release pattern determined by the release pattern determination section match to be lower than the difficulty in the case where the second user does not select the prediction release pattern.

11. A game control method, for controlling by a computer, a competitive game wherein a flying object released by a first personified character is hit back by a second personified character, comprising:
an image display step executed by the computer for displaying an image perceived in a direction from the second personified character to the first personified character;
a release pattern storing step executed by the computer for storing a plurality of release patterns, each defining a movement of the flying object to be released by the first personified character;
a release pattern option display step executed by the computer for displaying the release patterns stored in the release pattern storing step in the screen as selectable release pattern options;
a release pattern determination step executed by the computer for determining a release pattern of the flying object by the first personified character by selecting one of the release patterns stored in the release pattern storing step;
a release pattern prediction step executed by the computer for determining a prediction release pattern for the release pattern of the flying object to be released by the first personified character by selecting one of the plurality of release patterns stored in the release pattern storing step based on a selecting operation based on a selecting operation by a user operating the second personified character; and
a difficulty adjustment section executed by the computer for adjusting a difficulty for the second personified character to hit back the flying object released by the first personified character, said difficulty adjustment section comparing the release pattern determined by the release pattern determination step with the prediction release pattern determined by the release pattern prediction step and reducing the difficulty when the release pattern determined by the release pattern determination step and the prediction release pattern determined by the release pattern determination step match, to be lower than the difficulty in the case where the prediction release pattern is not selected.

12. A computer readable recording medium recorded with a game control program which executes a competitive game wherein a flying object released by a first personified character is hit back by a second personified character, for causing a computer to execute:
an image display step for displaying an image perceived in a direction from the second personified character to the first personified character;
a release pattern storing step for storing a plurality of release patterns, each defining a movement of the flying object to be released by the first personified character;
a release pattern option display step for displaying the release patterns stored in the release pattern storing step in the screen as selectable release pattern options;
a release pattern determination step for determining a release pattern of the flying object by the first personified character by selecting one of the release patterns stored in the release pattern storing step;
a release pattern prediction step for determining a prediction release pattern for the release pattern of the flying object to be released by the first personified character by selecting one of the plurality of release patterns stored in the release pattern storing step based on a selecting operation based on a selecting operation by a user operating the second personified character; and
a difficulty adjustment section for adjusting a difficulty for the second personified character to hit back the flying object released by the first personified character, said difficulty adjustment section comparing the release pattern determined by the release pattern determination step with the prediction release pattern determined by the release pattern prediction step and reducing the difficulty when the release pattern determined by the release pattern determination step and the prediction release pattern determined by the release pattern determination step match, to be lower than the difficulty in the case where the prediction release pattern is not selected.
